(19) United States
(12) Patent Application Publication
(10) Pub. No.: US 2019/0346338 A1
(43) Pub. Date: Nov. 14, 2019

(54) SYSTEMS AND METHODS FOR EVALUATING AND MAINTAINING STRUCTURAL INTEGRITY

(71) Applicant: Bechtel Oil, Gas & Chemicals, Inc., Houston, TX (US)

(72) Inventors: Dayne Meyer, Houston, TX (US); Robert Scott, Houston, TX (US); Sean Henry, Houston, TX (US); Daniel Jahnke, Houston, TX (US)

(73) Assignee: Bechtel Oil, Gas & Chemicals, Inc., Houston, TX (US)

(21) Appl. No.: 15/560,190

(22) PCT Filed: Jun. 23, 2017
(86) PCT No.: PCT/US17/39058

§ 371 Date: Sep. 21, 2017

Related U.S. Application Data
(60) Provisional application No. 62/450,351, filed on Jan. 25, 2017.

(51) Int. Cl. G01M 5/00; G06F 17/18

(52) U.S. Cl. CPC G01M 5/0033; G06F 17/18; G01M 5/0025

(57) ABSTRACT

Systems and methods for evaluating structural integrity by predicting failure and corresponding consequences for different components in a respective structure using geospatial data for criteria related to the structure components and multiple weights assigned to each respective criterion. The integrity of the structure is maintained by inspecting, repairing and/or replacing one or more components in the structure based on the predicted structural failure and its corresponding consequence.

### CROSS-REFERENCE TO RELATED APPLICATIONS

The priority of U.S. Provisional Patent Application No. 62/450,351, filed Jan. 25, 2017, is hereby claimed and the specification thereof is incorporated herein by reference.

### FIELD OF THE DISCLOSURE

The present disclosure generally relates to systems and methods for evaluating and maintaining structural integrity. More particularly, the present disclosure relates to evaluating structural integrity by predicting failure and corresponding consequences for different components in a respective structure using geospatial data for criteria related to the structural components and multiple weights assigned to each respective criterion. The integrity of the structure is maintained by inspecting, repairing and/or replacing one or more components in the structure based on the predicted structural failure and its corresponding consequence.

### BACKGROUND

Some conventional systems and methods for evaluating and maintaining structural integrity consider multiple probability of failure criteria and failure consequence criteria for each structural component. The probability of failure criteria include respective multipliers and respective weights. The failure consequence criteria include respective weights. Each weight is associated with a yes or no response to a single database query. Each weight is thus, either a (0) or a (1). The weight associated with each probability of failure criterion is based on historical frequencies of occurrence in the industry—not severity of the failure. Moreover, the weight associated with each failure consequence criterion is based on its monetary impact—not its impact on the surrounding environment/population/structures.

The criteria, multipliers and weights are typically set-meaning they may not be modified to account for the structural data that is available. Structural data includes historical data related to the structure but excludes data that is geospatially associated with the structural components. In other words, the structural data excludes geospatial data for evaluating structural integrity such as, for example, historical data that is geospatially associated with the area of a structure (e.g. fault lines, flood zones, earthquakes, soil studies, critical habitats, places of interest, landslide prone areas, roads, railroads, other nearby pipelines and rivers).

The structural data are correlated with i) the probability of failure criteria, respective multipliers and respective weights; and ii) the failure consequence criteria and respective weights. A probability of failure rank and a failure consequence rank are determined for each structural component based on the multiplication of each together, as in a Monte Carlo simulation. The failure consequence rank is based, in part, on the probability of failure rank to arrive at a monetary value. There is no geospatial representation of each structural component displayed with its probability of failure rank and a failure consequence rank. In short, the lack of multiple database queries for each criterion, the lack of geospatial data and the dependence of the failure consequence rank on the probability of failure rank render conventional systems and methods for evaluating and maintaining structural integrity less than desirable in accuracy. This can lead to wasted time and money for needless inspections, without providing a relative ranking system of potential failure and their respective consequence.

### BRIEF DESCRIPTION OF THE DRAWINGS

The present disclosure is described with reference to the accompanying drawings, in which like elements are referenced with like reference numbers, and in which:

FIGS. 1A-1B are a flow diagram illustrating one embodiment of a method for implementing the present disclosure.

FIGS. 2A-2H are tables illustrating a geographic information system (GIS) for evaluating the structural integrity of a pipeline by performing steps 110-112 in FIGS. 1A-1B.

FIG. 3 is a display illustrating one embodiment of a graphical user interface (GUI) for performing step 114 in FIG. 1B.

FIG. 4 is a display illustrating one embodiment of a GUI for performing step 116 in FIG. 1B.

FIG. 5 is a display illustrating another embodiment of the GUI in FIG. 4 for performing step 116 in FIG. 1B.

FIG. 6 is a display illustrating another embodiment of the GUI in FIG. 4 for performing step 116 in FIG. 1B.

FIG. 7 is a display illustrating one embodiment of a GUI for performing step 120 in FIG. 1B.

FIG. 8 is a block diagram illustrating one embodiment of a computer system for implementing the present disclosure.

### DETAILED DESCRIPTION OF THE ILLUSTRATIVE EMBODIMENTS

The subject matter of the present disclosure is described with specificity, however, the description itself is not intended to limit the scope of the disclosure. The subject matter thus, might also be embodied in other ways, to include different structures, steps and/or combinations similar to and/or fewer than those described herein, in conjunction with other present or future technologies. Although the term “step” may be used herein to describe different elements of methods employed, the term should not be interpreted as implying any particular order among or between various steps herein disclosed unless otherwise expressly limited by the description to a particular order. Other features and advantages of the disclosed embodiments will be or will become apparent to one of ordinary skill in the art upon examination of the following figures and detailed description. It is intended that all such additional features and advantages be included within the scope of the disclosed embodiments. Further, the illustrated figures are only exemplary and are not intended to assert or imply any limitation with regard to the environment, architecture, design, or process in which different embodiments may be implemented.

The systems and methods of the present disclosure overcome one or more of the prior art disadvantages by predicting failure and corresponding consequences for different components in a respective structure using geospatial data for criteria related to the structural components and multiple weights assigned to each respective criterion.

In one embodiment, the present disclosure includes a method for evaluating and maintaining structural integrity, which comprises: a) inputting structural data and geospatial data into a geographical information system for each structural component; b) inputting i) probability of failure criteria, a respective multiplier and respective weights into the geographical information system for each structural component and ii) failure consequence criteria and respective weights into the geographical information system for each structural component; c) correlating the structural data and the geospatial data for each structural component with i) the probability of failure criteria or modified probability of failure criteria, the respective multiplier or a modified respective multiplier and each respective weight or each modified respective weight and ii) the failure consequence criteria or modified failure consequence criteria and each respective weight or each modified respective weight; d) determining a relative probability of failure rank and an independent failure consequence rank for each structural component based on the correlation from step c) using a computer processor; e) displaying a representation of each structural component in a matrix on a computer monitor based on the relative probability of failure rank and the independent failure consequence rank for each structural component; and f) inspecting one or more structural components based on the display.

In another embodiment, the present invention includes a non-transitory program carrier device tangibly carrying computer-executable instructions for evaluating and maintaining structural integrity, the instructions being executable to implement; a) inputting structural data and geospatial data into a geographical information system for each structural component; b) inputting i) probability of failure criteria, a respective multiplier and respective weights into the geographical information system for each structural component and ii) failure consequence criteria and respective weights into the geographical information system for each structural component; c) correlating the structural data and the geospatial data for each structural component with i) the probability of failure criteria or modified probability of failure criteria, the respective multiplier or a modified respective multiplier and each respective weight or each modified respective weight and ii) the failure consequence criteria or modified failure consequence criteria and each respective weight or each modified respective weight; d) determining a relative probability of failure rank and an independent failure consequence rank for each structural component based on the correlation from step c); e) displaying a representation of each structural component on a matrix based on the relative probability of failure rank and the independent failure consequence rank for each structural component; and f) inspecting one or more structural components based on the display.

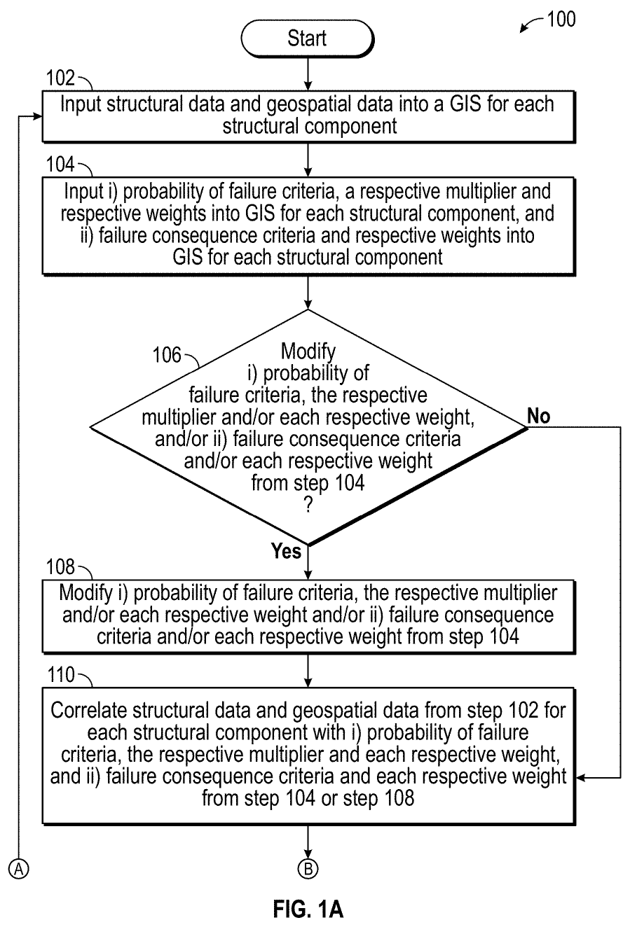

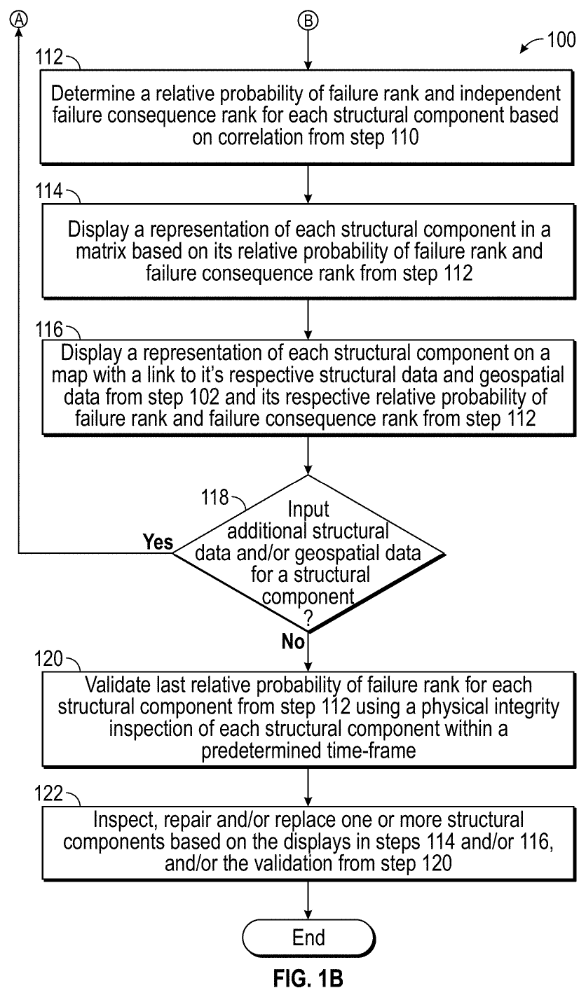

Referring now to FIGS. 1A-1B, a flow diagram illustrates one embodiment of a method 100 for implementing the present disclosure. In one embodiment, the method 100 may be used for evaluating and maintaining the integrity of sub-surface pipeline structures. In this embodiment, the method 100 provides a pipeline integrity status of in-service pipelines and areas of concern, which may be used to respond to potential pipeline integrity issues proactively as opposed to retroactively. The method 100 thus, may be particularly useful for evaluating and maintaining the integrity of approximately 295,000 miles of sub-surface natural gas pipelines that are required to be tested, as well as 200,000 miles of hazardous liquid pipelines in the U.S.A. Pipelines built before 1970 are currently exempted from certain pipeline safety regulations because they were constructed and placed into operation before pipeline safety regulations were developed. Evaluation will require the utilization of “meaningful metrics” in pipeline analysis, and an accelerated timeframe for implementation: 50% of a company's existing mileage conforming to current regulations within eight years, followed by 100% of their remaining mileage within fifteen years.

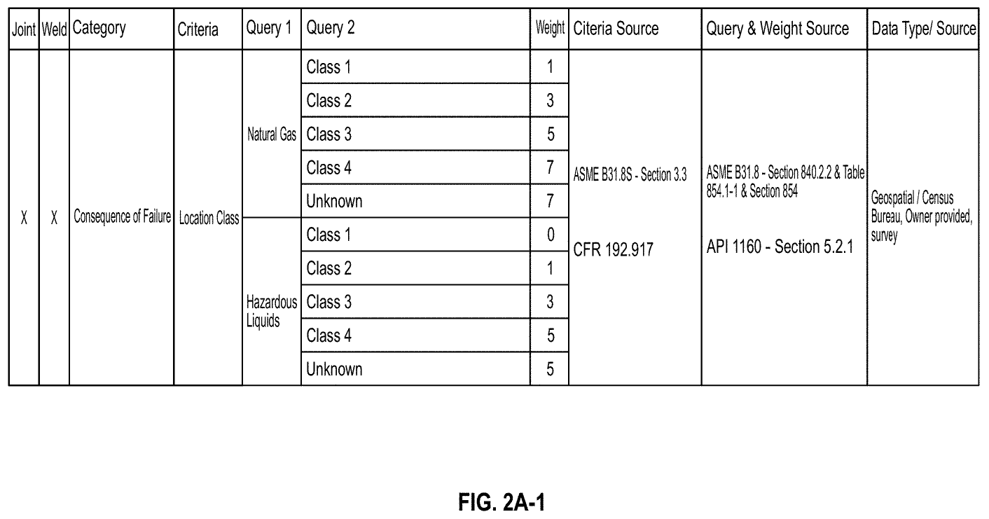

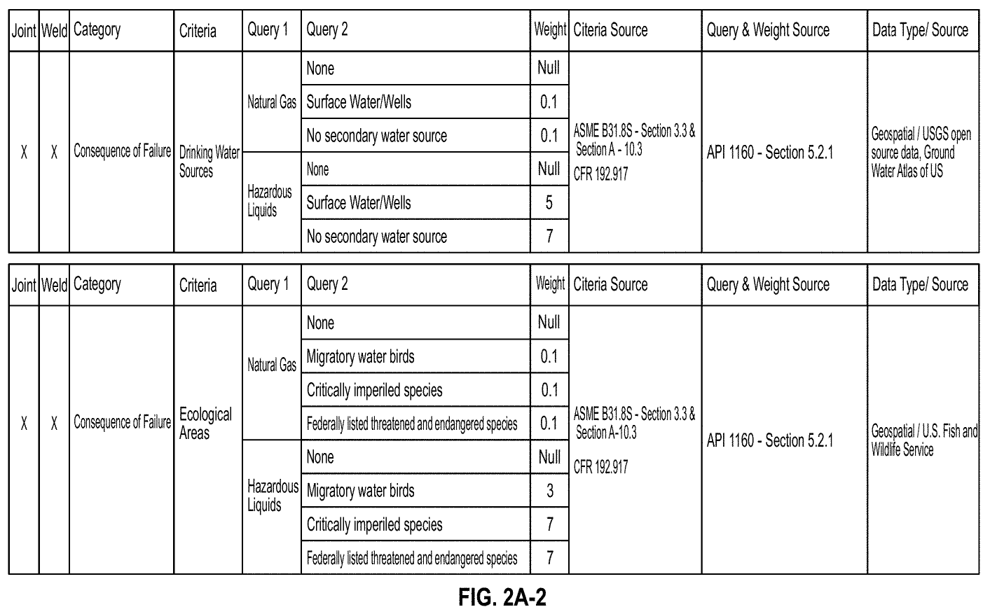

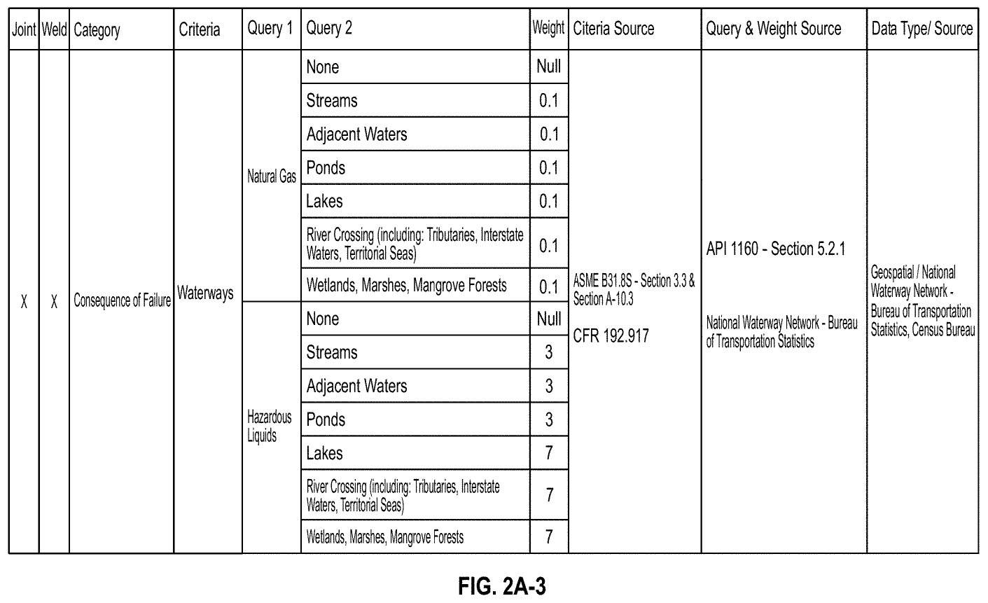

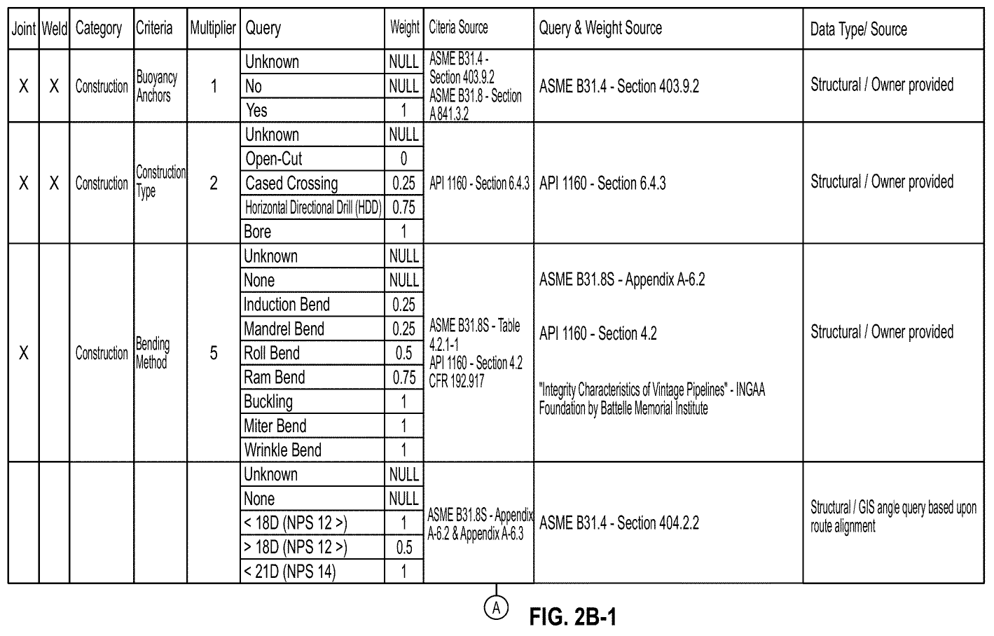

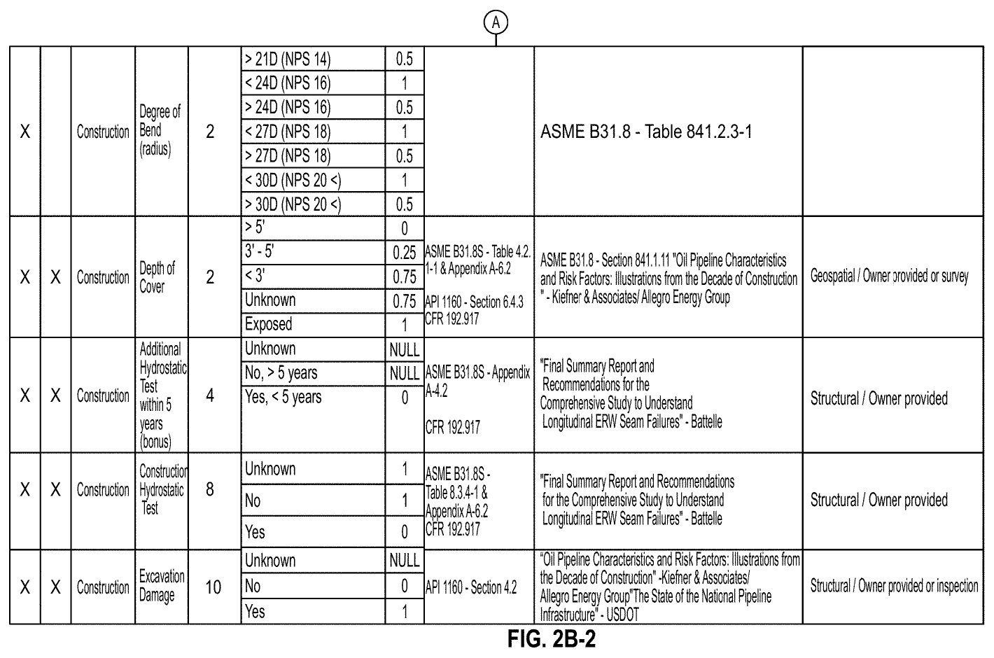

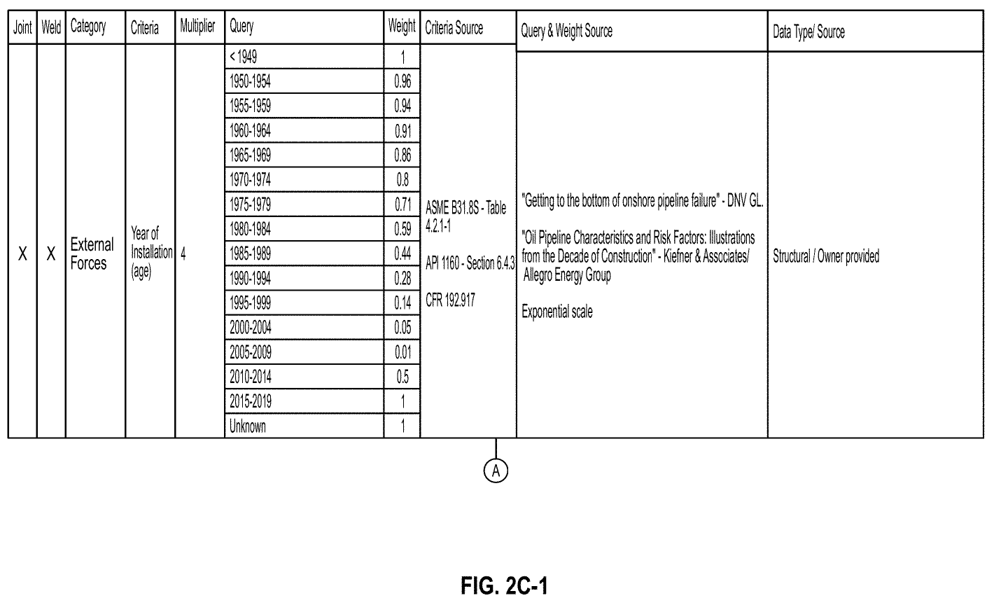

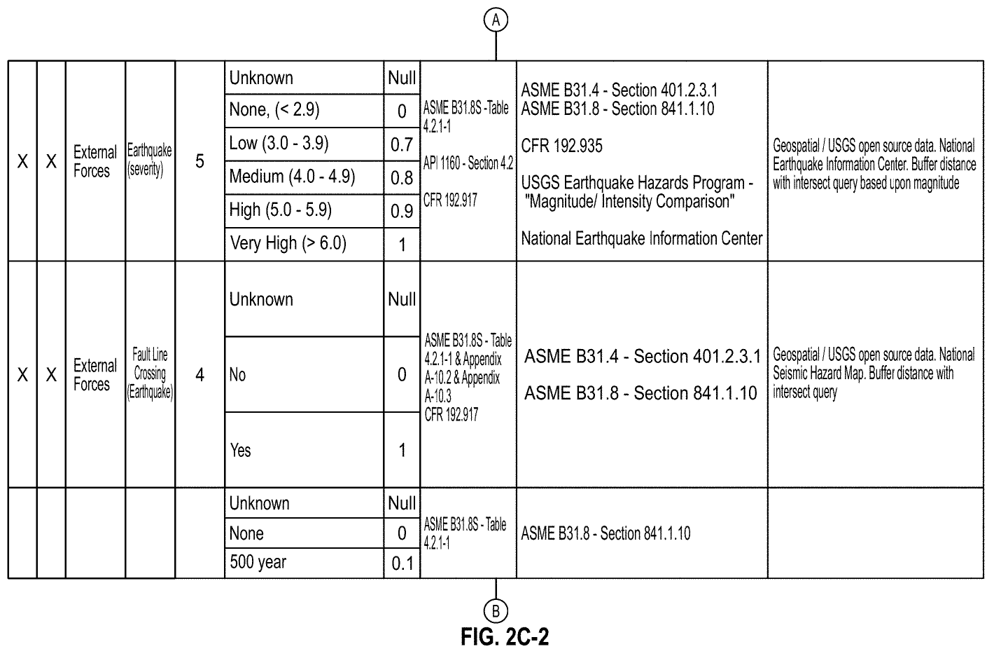

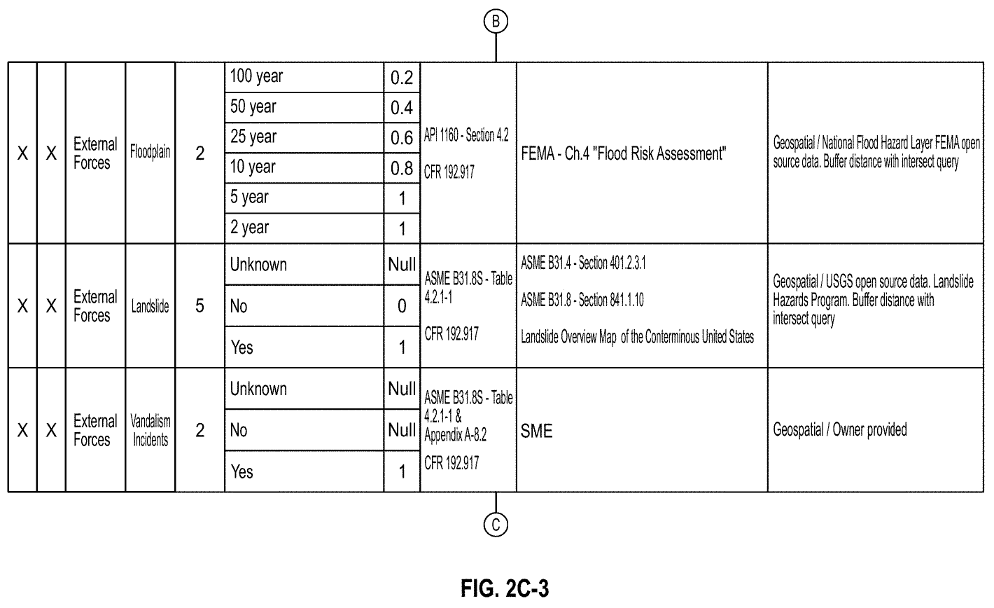

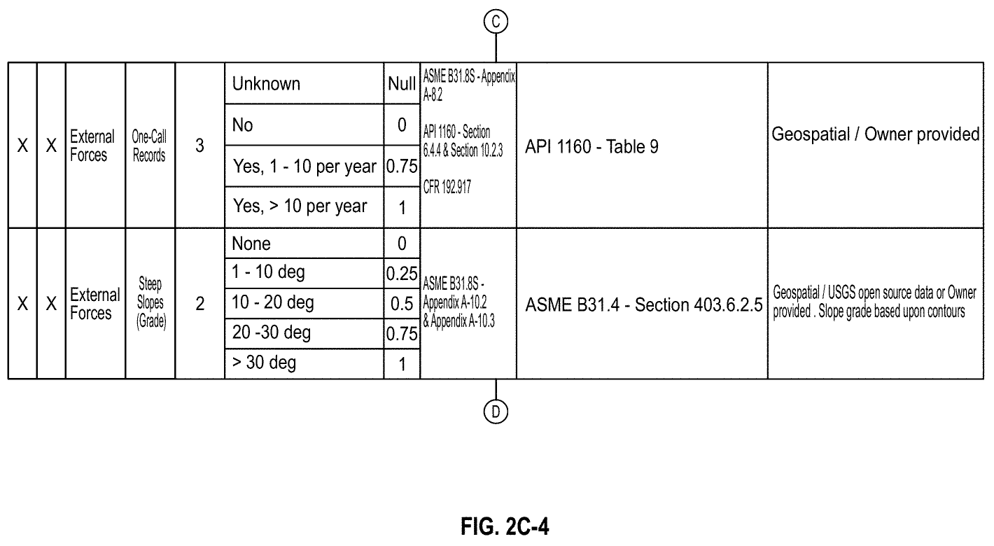

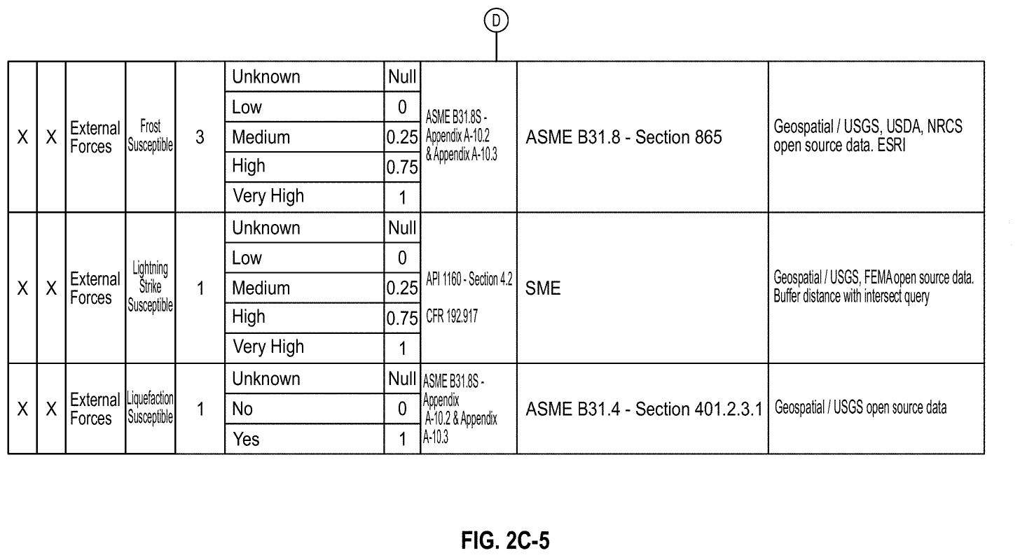

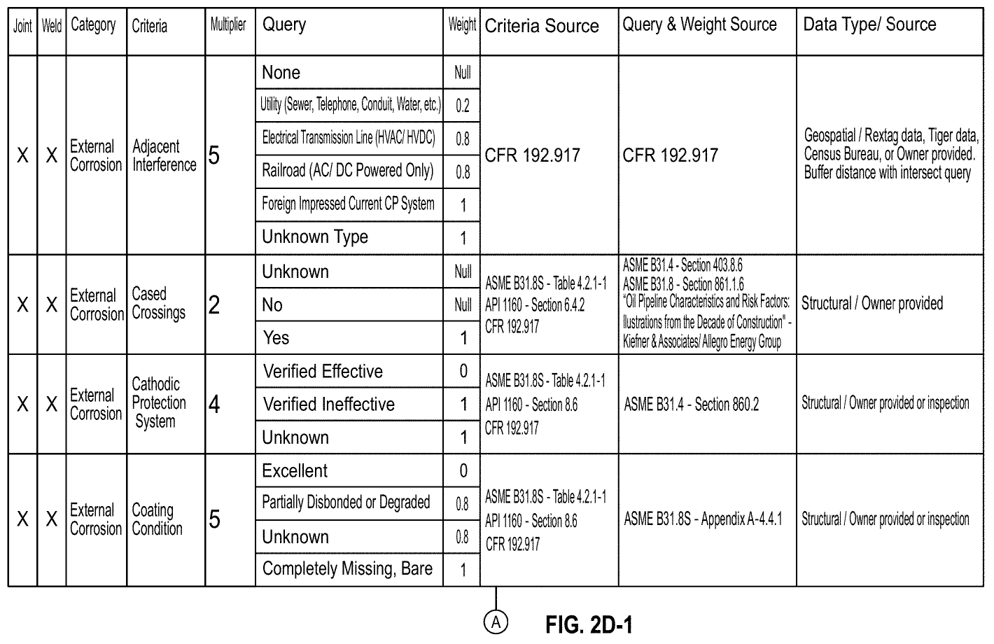

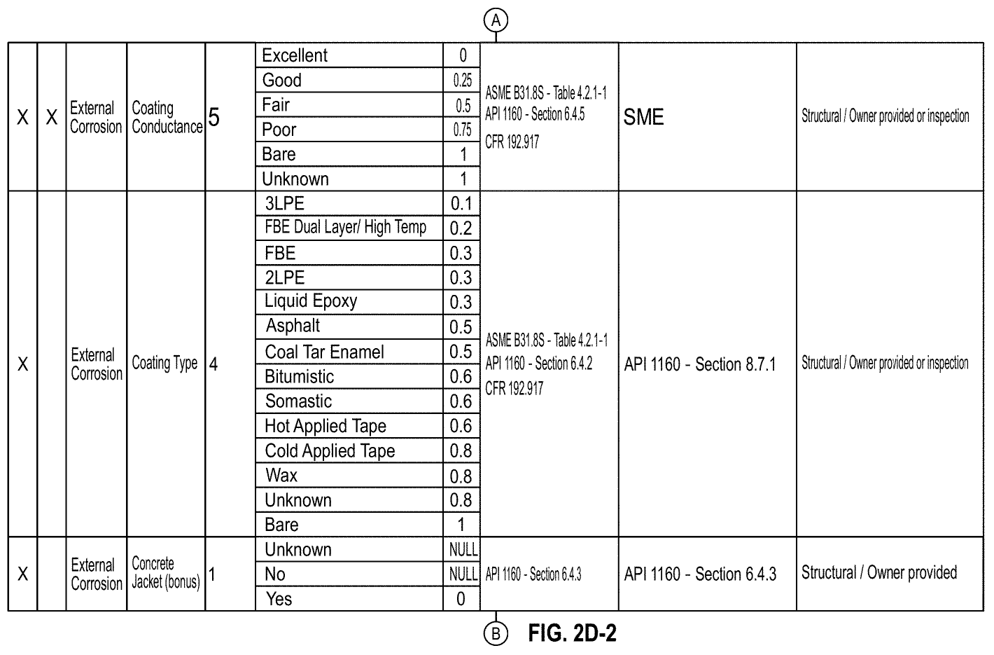

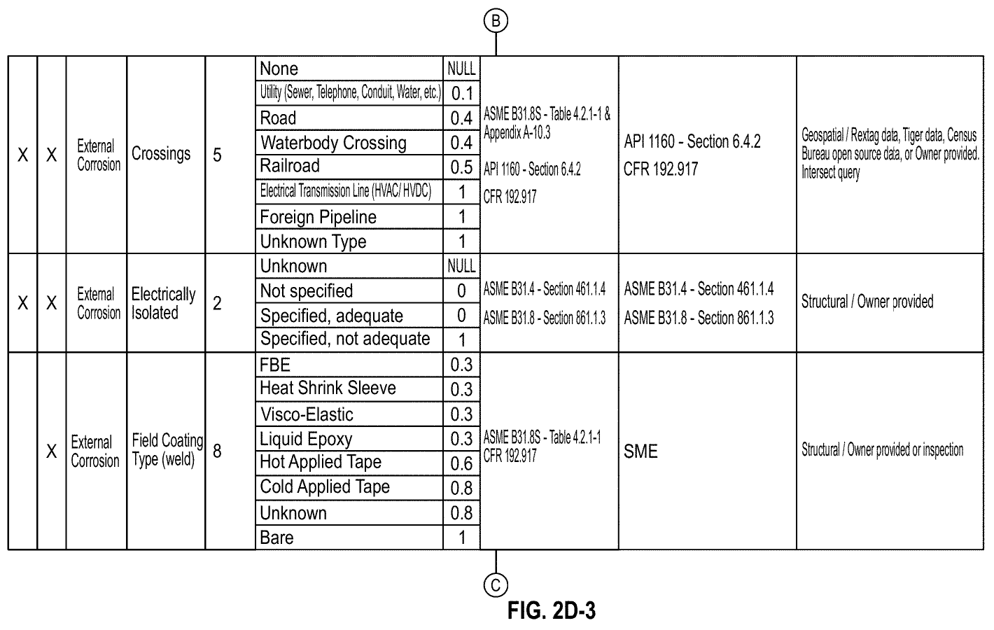

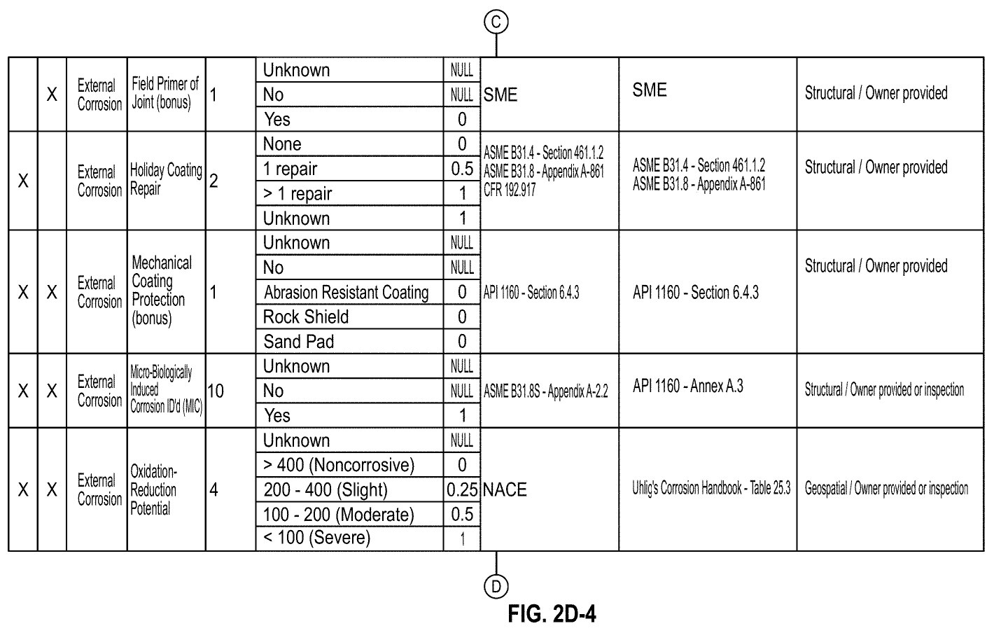

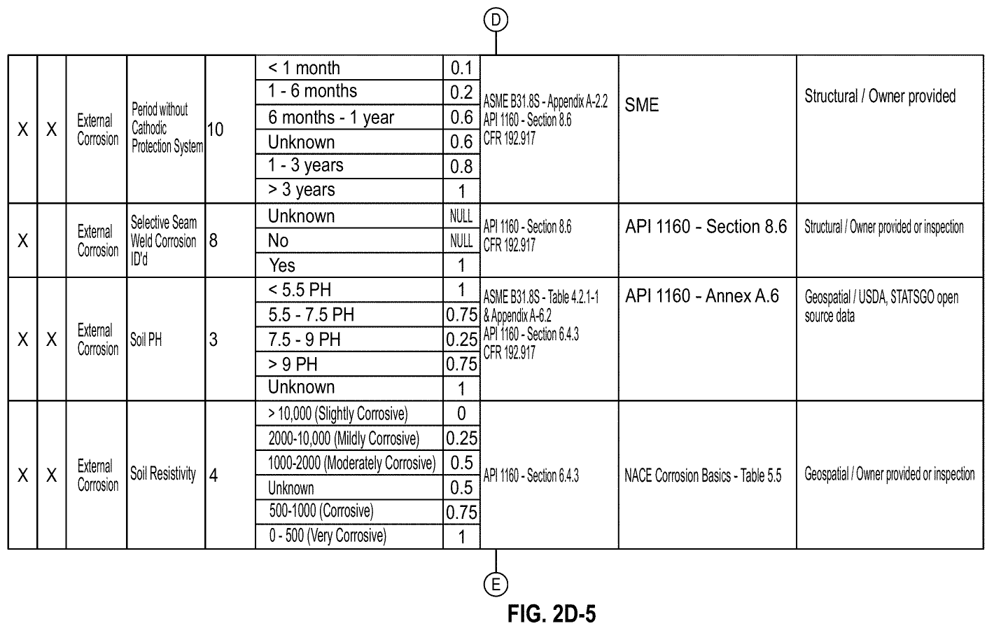

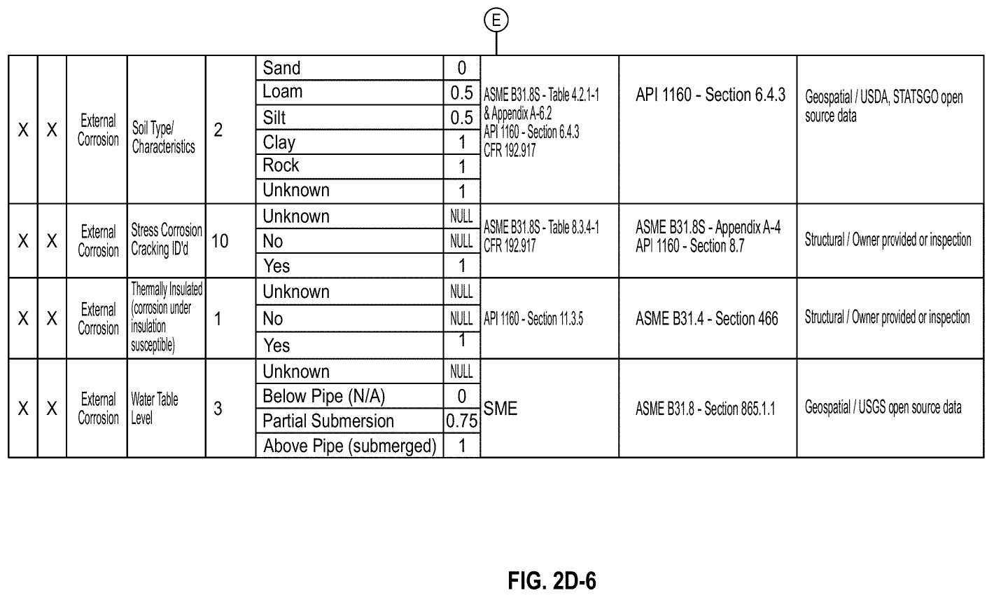

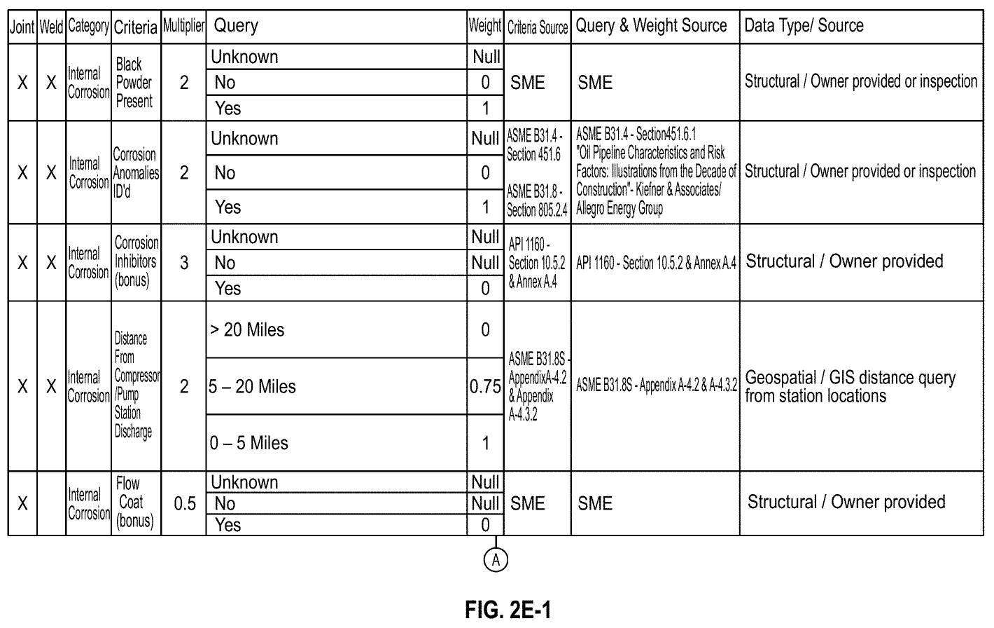

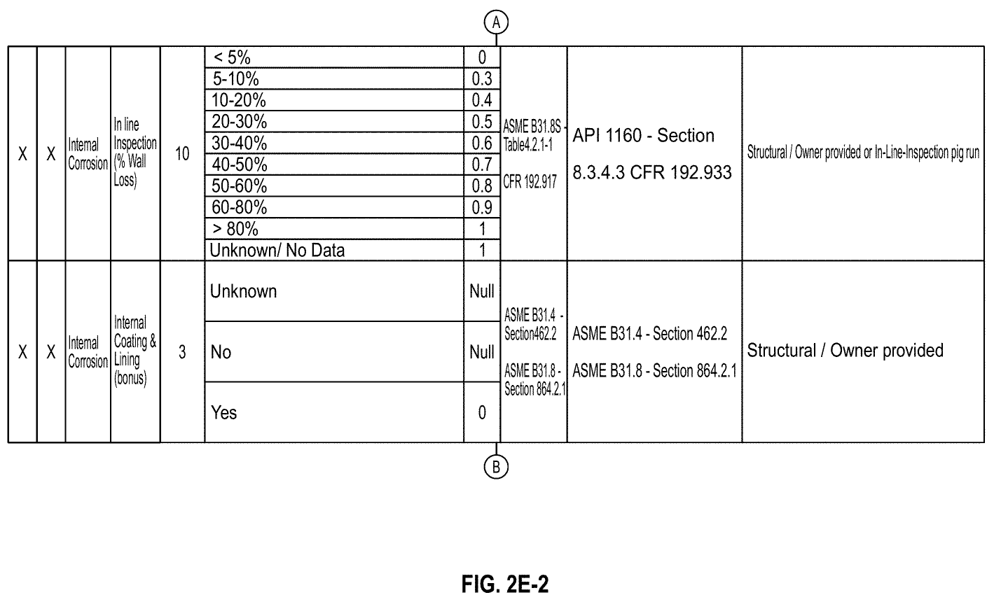

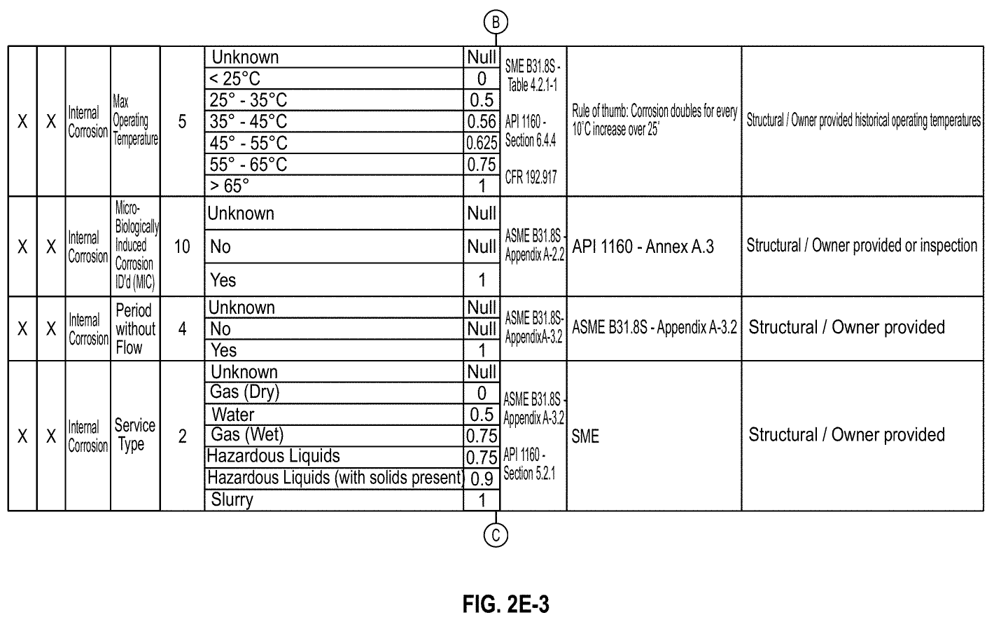

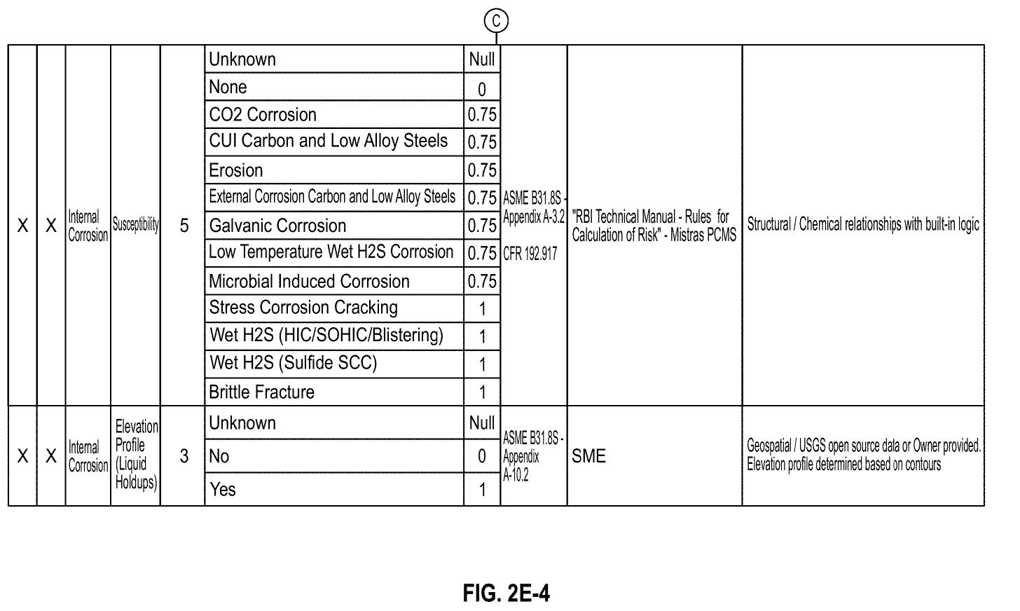

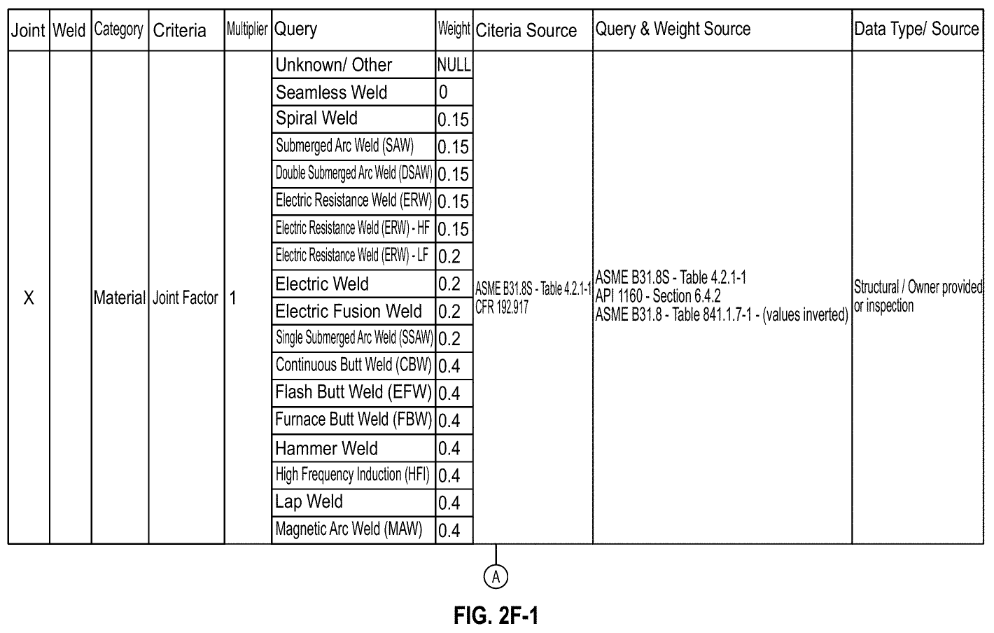

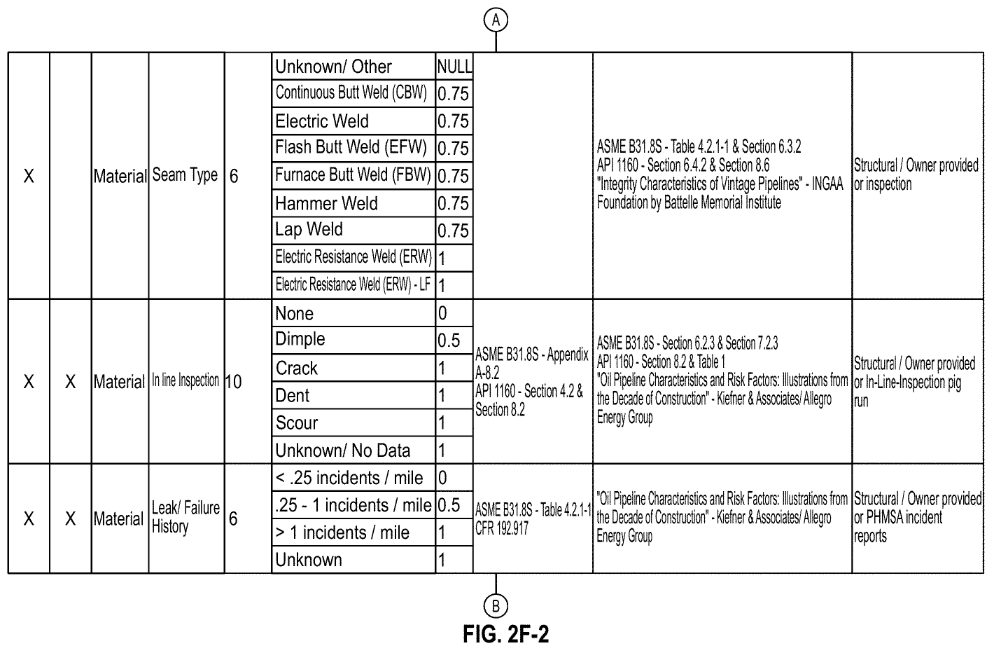

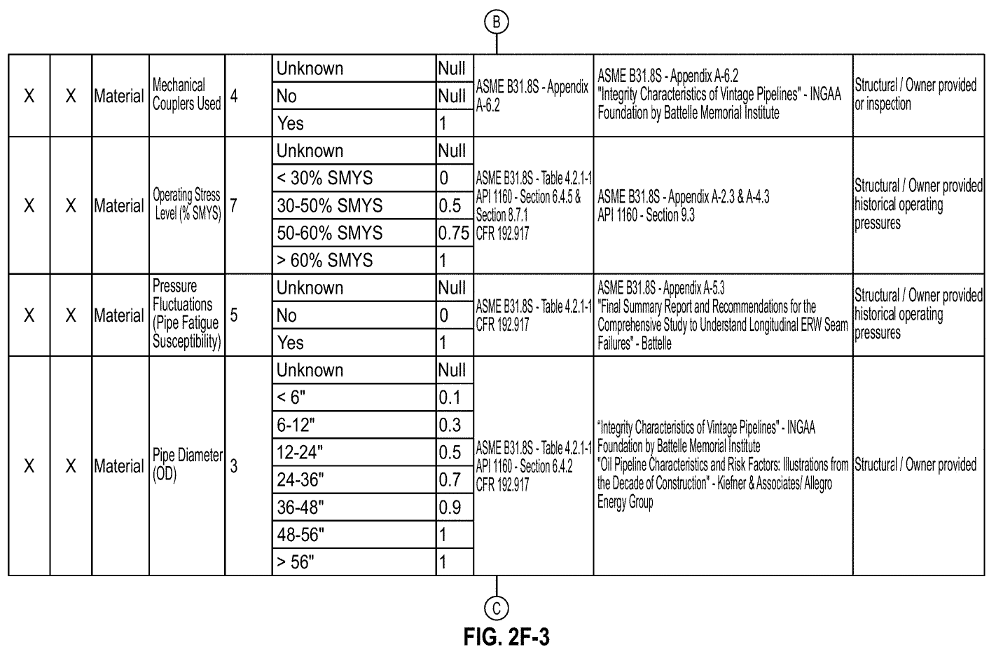

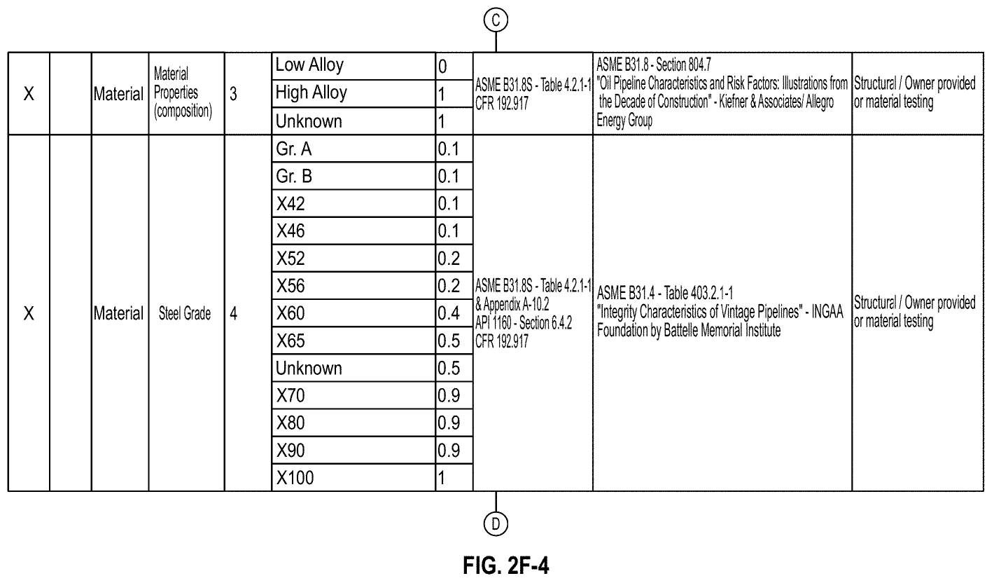

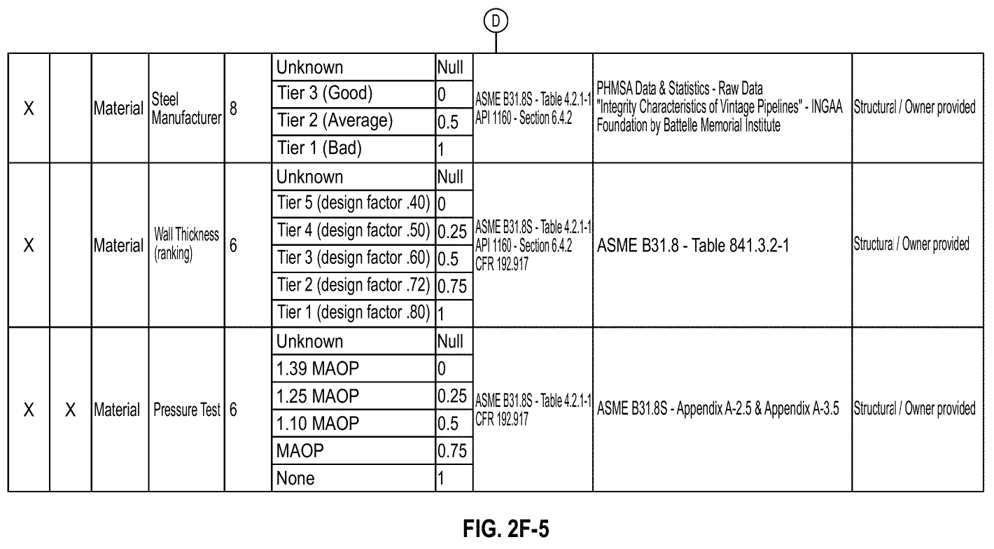

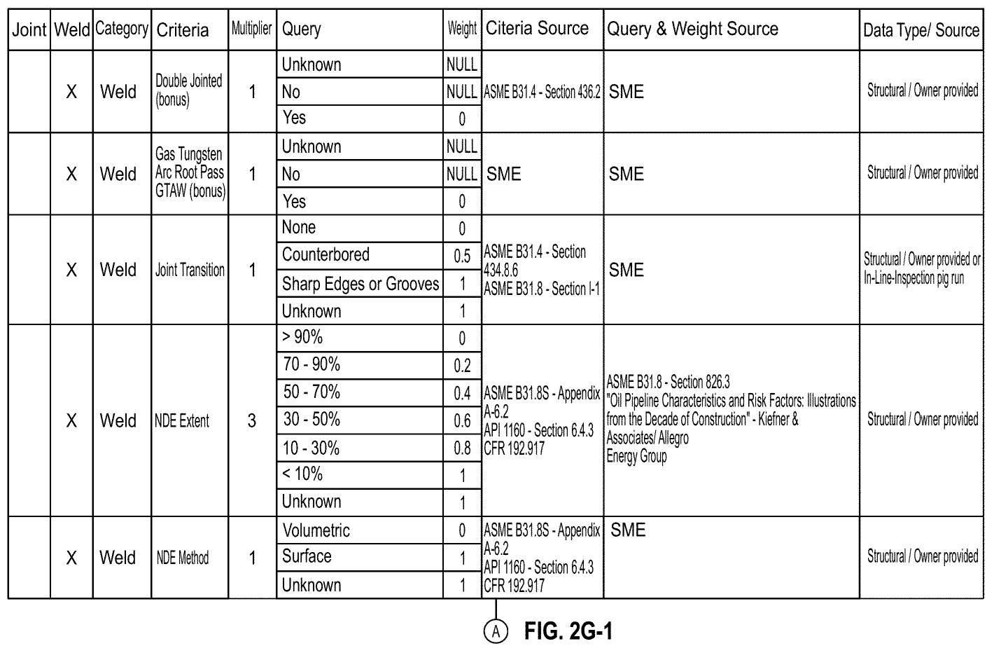

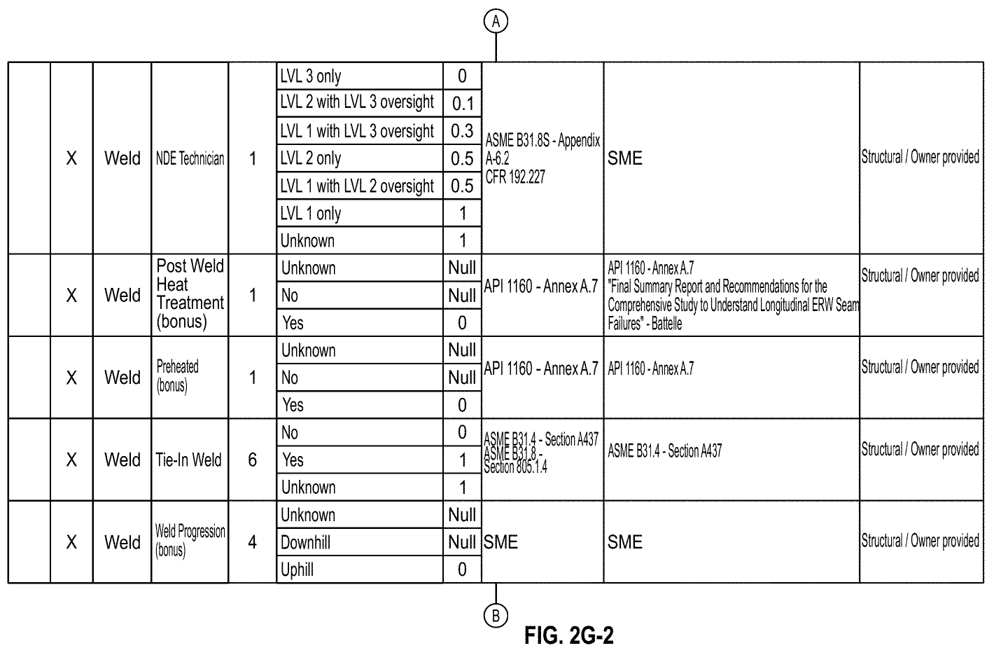

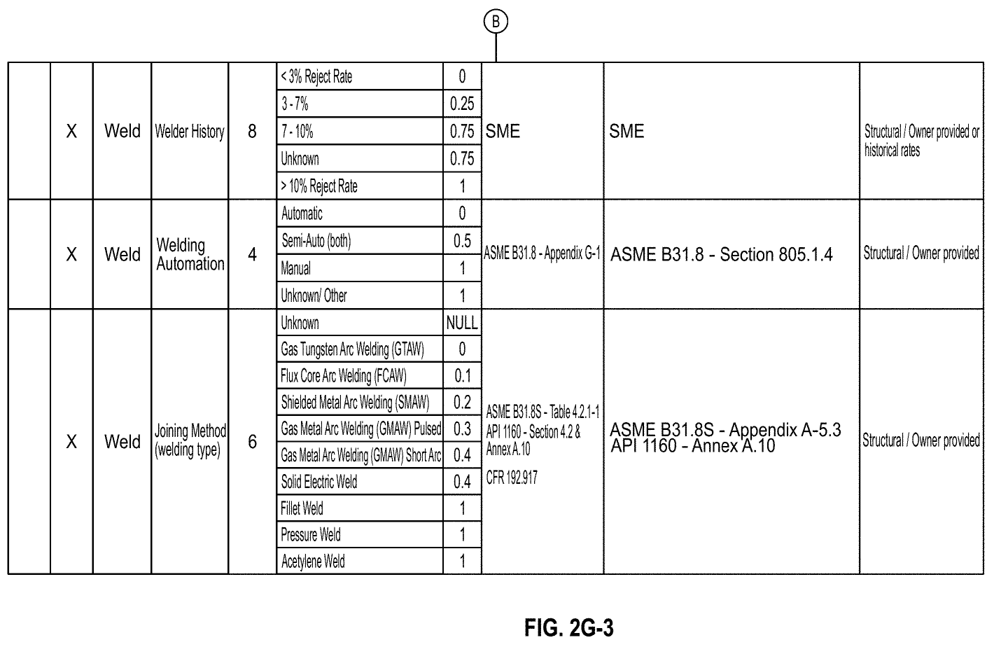

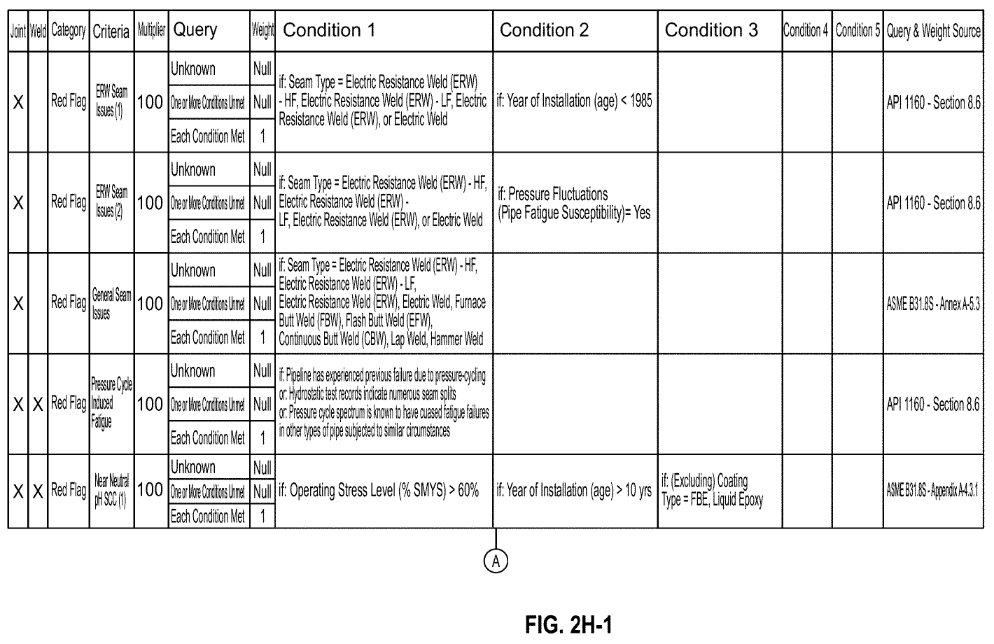

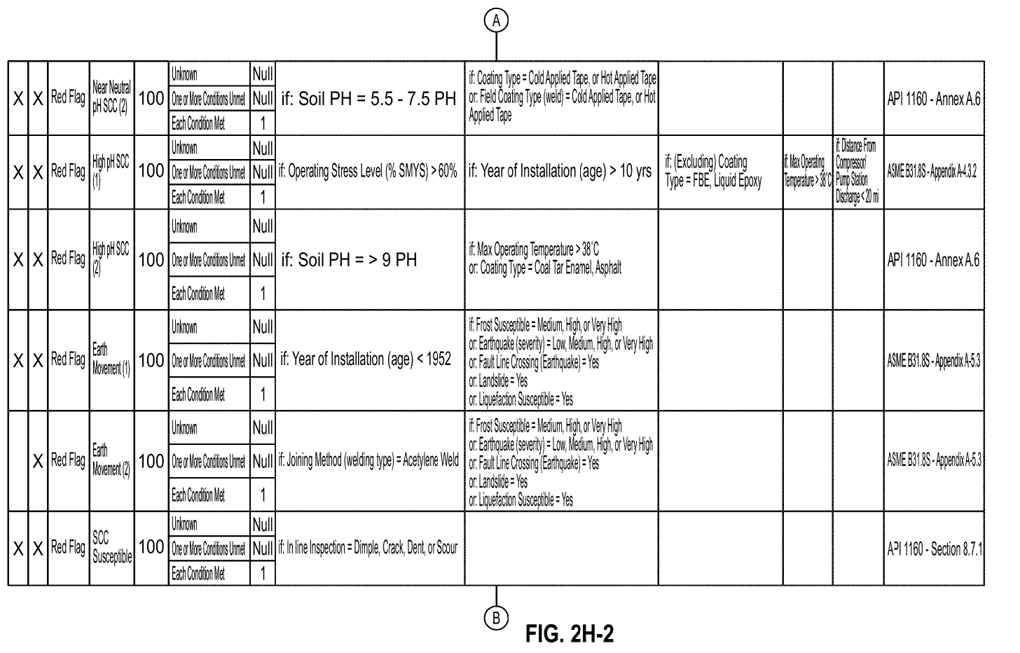

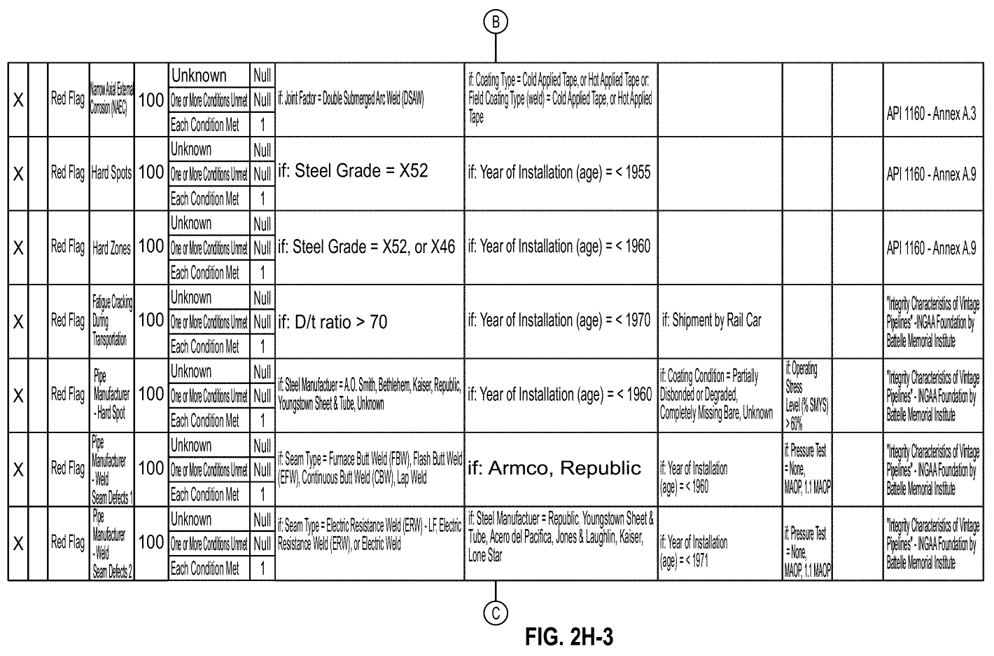

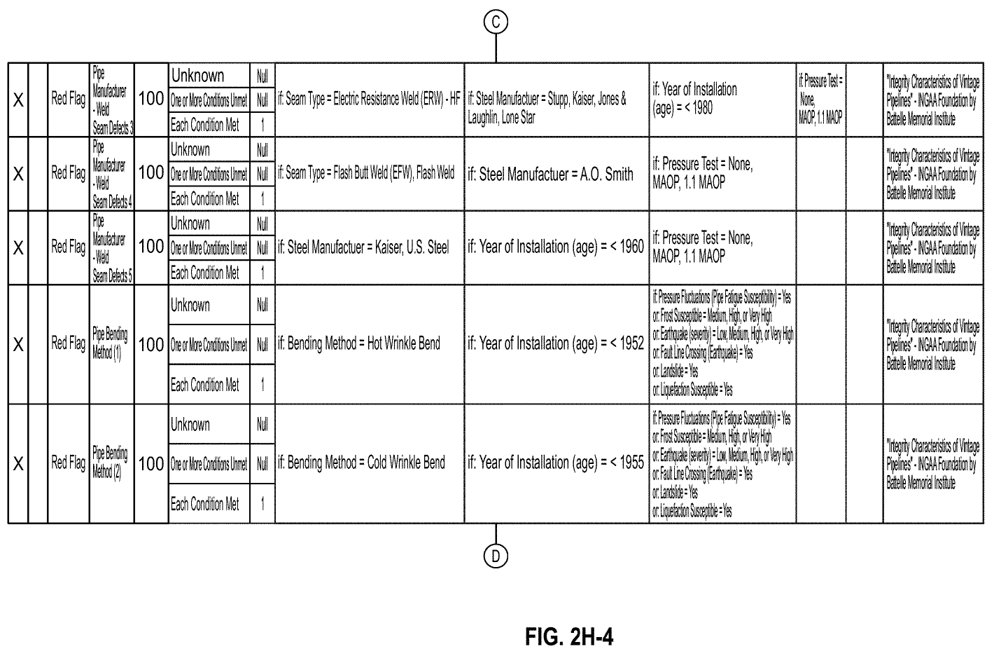

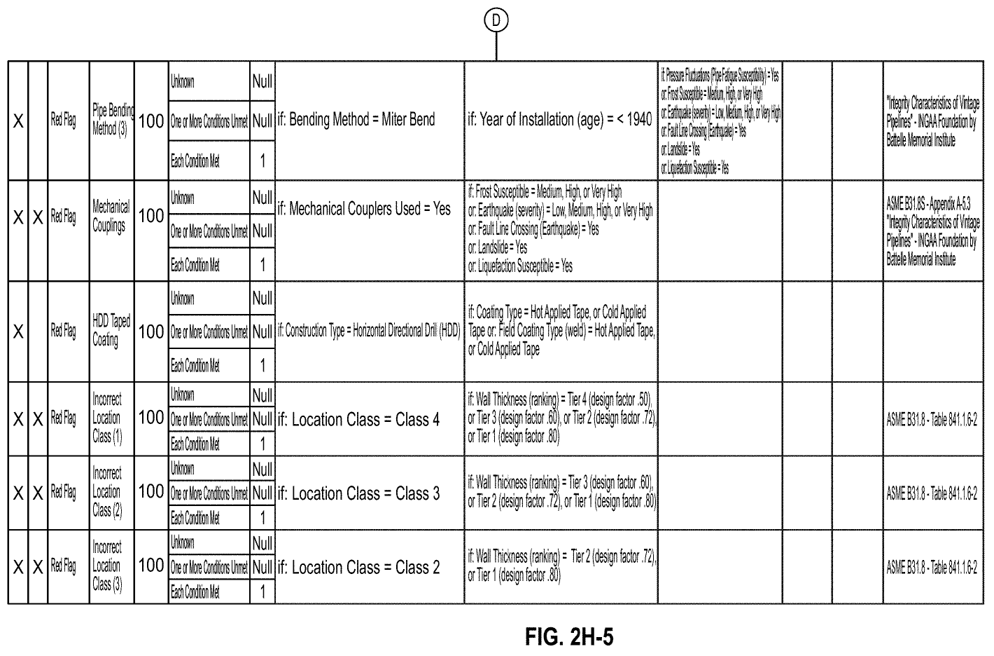

In step 102, structural data and geospatial data are automatically input into a GIS for each structural component. Typical structural data for evaluating the structural integrity of a pipeline may include, for example, pipeline type, pipeline coating type and welding type, pipeline protection, pipeline service results from an in-line pigging inspection, previous pipeline failures and pipeline coordinates. The structural data therefore, may include historical data that is geospatially associated with the structural components of a preexisting pipeline (e.g. joints, welds, valves, etc.). Structural data that is not publicly accessible must be obtained from the pipeline owner or operator. Typical geospatial data for evaluating the structural integrity of a pipeline may include, for example, historical data that is geospatially associated with the area of a preexisting pipeline (e.g. fault lines, flood zones, earthquakes, soil studies, critical habitats, places of interest, landslide prone areas, roads, railroads, other nearby pipelines and rivers). Geospatial data may be applied to the entire structure or select structural components impacted most by the geospatial data. Geospatial data is usually accessible from public sources such as the US Geological Survey (USGS) (earthquakes, fault lines, landslides), Federal Emergency Management Agency (FEMA) (flood zones), US Department of Agriculture (USDA) (soil studies), US Fish & Wildlife Services (critical habitats), and Google Maps (places of interest, roads, railroads rivers). Geospatial data for preexisting pipelines may be obtained for a fee from Rextag. The structural data and geospatial data for evaluating the structural integrity of a pipeline are collectively part of the GIS illustrated in FIGS. 2A-2H.

In step 104, probability of failure criteria and failure consequence criteria are automatically input into the GIS for each structural component. The probability of failure criteria include a respective multiplier and respective weights. The failure consequence criteria include respective weights. Each weight is associated with a database query. Typical probability of failure criteria for evaluating the structural integrity of a pipeline may include, for example, the criteria that is part of the GIS illustrated in FIGS. 2B-2H. Typical failure consequence criteria for evaluating the structural integrity of a pipeline may include, for example, the criteria that is part of the GIS illustrated in FIG. 2A. The probability of failure criteria and failure consequence criteria are based on the type of structure and may include criteria determined by industry standards and/or regulated by government agencies such as, for example, the Pipeline and Hazardous Materials Safety Administration (PHMSA), American Society of Mechanical Engineers (ASME), National Association of Corrosion Engineers (NACE), American Petroleum Institute (API), Environmental Protection Agency (EPA), USGS and FEMA. In FIG. 2A, there are four (4) failure consequence criteria that each apply to every structural component (i.e. joint, weld) in the pipeline. Each failure consequence criterion includes a plurality of respective weights that are each associated with a database query1 and a database query2. The database query1 simply determines whether the pipeline product is a natural gas or hazardous liquids based on structural data for the pipeline from step 102. Database query2 determines the respective weight in step 110 based on structural data and geospatial data for the pipeline from step 102. The source of each criterion, query, weight and data is also included in the GIS but is optional. Each failure consequence criterion may be based on its impact on the surrounding environment/population/structures-instead of a monetary impact. In FIGS. 2B-2H, there are eighty-one (81) probability of failure criteria, separated into six (6) categories, that each apply to specified structural components (i.e. joint and/or weld) in the pipeline. Each probability of failure criterion includes a single multiplier and a plurality of respective weights that are each associated with a database query. The database query determines the respective weight in step 110 based on structural data and geospatial data for the pipeline from step 102. A database query may be temperature or time dependent and the associated weight is preferably based on severity of the failure—not frequency of occurrence. The source of each criterion, query, weight and data is also included in the GIS but is optional. The source of each multiplier is preferably a subject matter expert. There are also several factors which decrease the probability of a failure such as recently performing a hydrotest of the pipeline, utilizing corrosion inhibitors, or having internal coating and lining. For these factors a weight of 0 is applied as a bonus, thereby reducing the overall relative probability of failure rank determined in step 112.

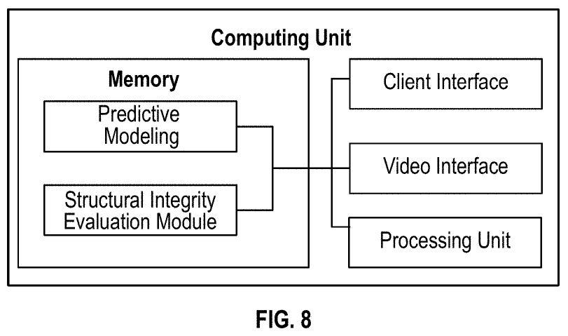

In step 106, the method 100 determines whether to modify i) the probability of failure criteria, the respective multiplier and/or each respective weight; and/or ii) the failure consequence criteria and/or each respective weight from step 104. Modification may be based on the type of structure, its components and/or the data available as input in step 102. The determination may be automatic or may be made using the client interface, the video interface and/or the GUI described further in reference to FIG. 8. If modification is not required, then the method 100 proceeds to step 110. Otherwise, the method 100 proceeds to step 108.

In step 108, the i) probability of failure criteria, the respective multiplier and/or each respective weight; and/or the ii) failure consequence criteria and/or each respective weight from step 104 are modified using the client interface, the video interface and/or the GUI described further in reference to FIG. 8. Modification may include removing and/or adding criteria respective multipliers and/or respective weights. Modification may also include adjusting the multipliers, the weights and/or the database query associated with a respective weight. If certain data is not available as input in step 102 for a particular type of structure, for example, then modification may include removing the criteria, respective multipliers and/or respective weights requiring unavailable data to answer the database query associated with the respective weight in step 110.

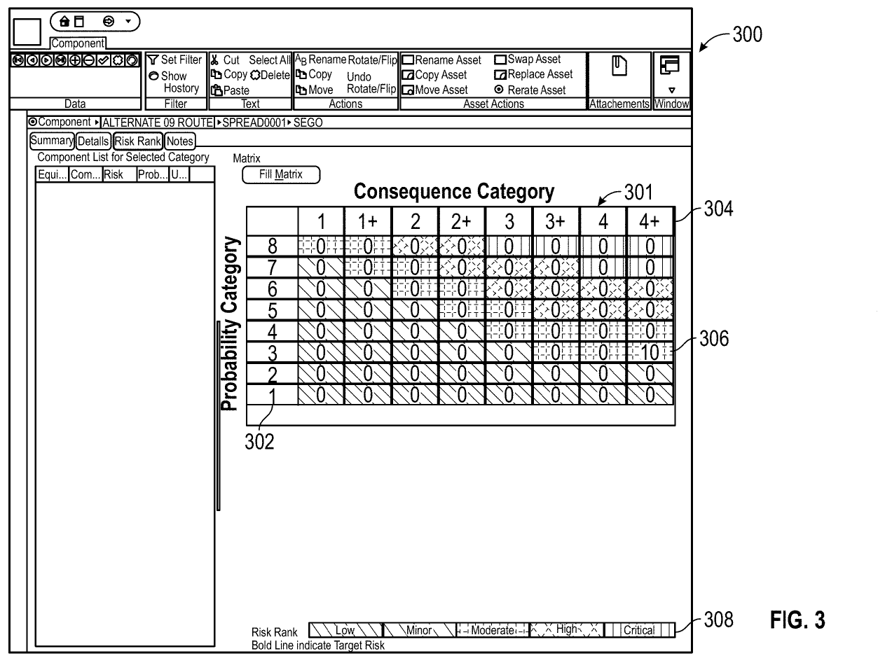

In step 110, the structural data and geospatial data from step 102 are automatically correlated with i) the probability of failure criteria, the respective multiplier and each respective weight; and ii) the failure consequence criteria and each respective weight from step 104 or step 108. Correlation finds the structural data and geospatial data for each structural component that most closely corresponds to one or more of the database queries associated with a respective weight for each structural component. Because each structural component includes multiple probability of failure criteria and failure consequence criteria and each criterion includes multiple weights associated with a respective database query, it is possible that the same or different structural data and geospatial data may correspond to more than one database query for any given criterion or the structural data and geospatial data may not correspond to any database query for any given criterion. If the same or different structural data and geospatial data corresponds to more than one database query for any given criterion, then the structural data and geospatial data are correlated with the database query associated with the highest respective weight representing a worst-case scenario. In FIG. 2A-2, for example, the same or different structural data and geospatial data may correspond to the database queries “migratory water birds” and “critically imperiled species” for the ecological areas criterion. In this event, the structural data and geospatial data would be correlated with the highest respective weight (3 or 7 for hazardous liquids) representing a worst-case scenario. In FIG. 2D-3, for example, the same or different structural data and geospatial data may correspond to the database queries “road” and “railroad” for the crossings criterion. In this event, the structural data and geospatial data would be correlated with the highest respective weight (0.5) representing a worst-case scenario. If the structural data and geospatial data does not correspond to any database query for any given criterion, then the structural data and geospatial data represent an unknown that is correlated with the database query “unknown” associated with a respective weight. The absence of structural data and geospatial data (i.e. does not correspond to any database query for any given criterion) should not be confused with structural data and geospatial data that corresponds to a database query of “no” or “none.” In FIG. 2D-3, for example, the database query “unknown type” for the crossings criterion is associated with a respective weight of (1), representing a worst-case scenario, and the database query “none” for the crossings criterion is associated with a respective null weight. In FIG. 2H, an optional “red flag” category may be used where certain combinations of correlations represent a heightened probability of failure. For example, each criterion in FIG. 2H includes one or more conditions that each represent part of the respective query. If each condition is met, then there is a correlation with a weight of (1). If each condition is not met or is unknown, then there is a correlation with a null weight.

In step 112, a relative probability of failure rank and a failure consequence rank are automatically and independently determined for each structural component based on the correlation from step 110. The relative probability of failure rank is determined by adding the weights associated with the correlated database queries from step 110 for each structural component and dividing the added weight for each structural component (representing a total weighted score) by a total weight representing the sum of the weights associated with a respective database query for each respective structural component. Any null weight associated with a correlated database query is not considered in the total weight representing the sum of the weights associated with a respective database query for each respective structural component. The failure consequence rank is independently determined by adding the weights associated with the correlated database queries from step 110 for each structural component. Thus, the relative probability of failure rank has no bearing on the determination of the failure consequence rank. In this manner, areas of higher risk to public health and safety based on the failure consequence rank may be addressed first, without bias to areas with a higher probability but in lower risk locations.

In step 114, a representation of each structural component is displayed in a matrix, using the client interface, video interface and/or the GUI described further in reference to FIG. 8, based on the relative probability of failure rank and failure consequence rank determined in step 112 for each structural component. In FIG. 3, a display 300 illustrates one embodiment of a GUI for displaying a representation of each structural component (e.g. joints and welds in a pipeline) in a matrix 301 based on the relative probability of failure rank and failure consequence rank for each structural component. The matrix 301 includes a probability category 302 and a consequence category 304. The probability category 302 comprises a plurality of rows (e.g. 1 . . . 8) for categorizing the relative probability of failure rank for each structural component. With the relative probability of failure rank being displayed as a relative decimal between components, the range between rows is proportionally scaled. Relative probability of failure ranks greater than 0.50 are classified into the 7th and 8th rows, with those under a relative probability of failure rank of 0.50 classified in rows 1-6. If a structural component, for example, has a 0.29 relative probability of failure rank, then its probability category will be a three (3), if a structural component has a 0.36 relative probability of failure rank, then its probability category will be a five (5). The consequence category 304 comprises a plurality of eight columns (e.g. 1 . . . 4+) for categorizing the failure consequence rank for each structural component. If a structural component, for example, has a three (3) failure consequence rank, then its consequence category will correspond to column 3 (2). Any structural component with a consequence failure rank higher than seven (7) will have a 4+ consequence category. Each matrix cell (e.g. 306) includes a number that represents the number of structural components with the same probability category and consequence category. If a matrix cell includes a ten (10), then there are 10 structural components with the same probability category and consequence category. Each matrix cell may include shading that is part of a grayscale risk rank 308 for easily identifying structural components with a low to high degree of risk based on the probability category and the consequence category for each matrix cell. Each matrix cell may also include a link to each structural component its number represents and a display of each structural component on a map.

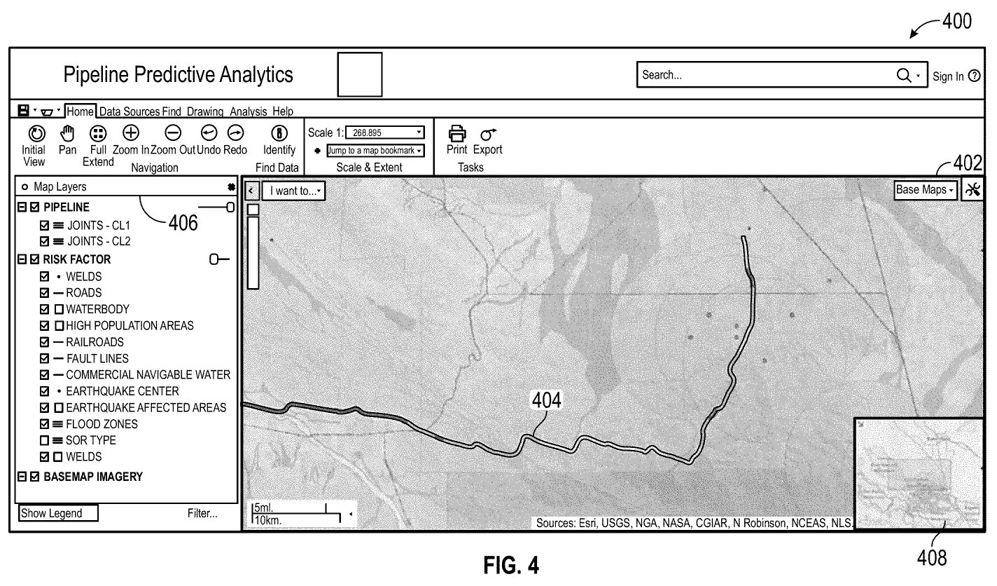

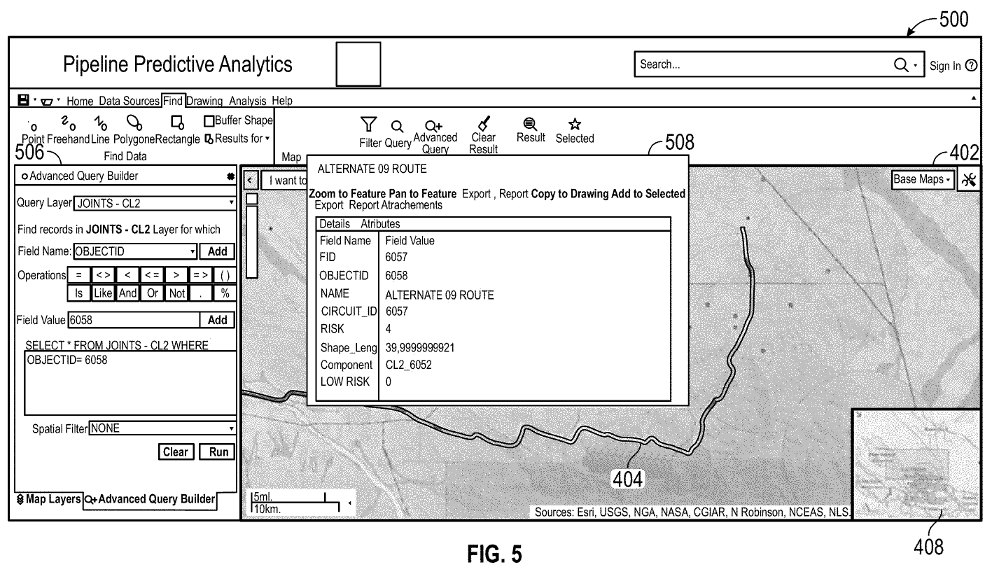

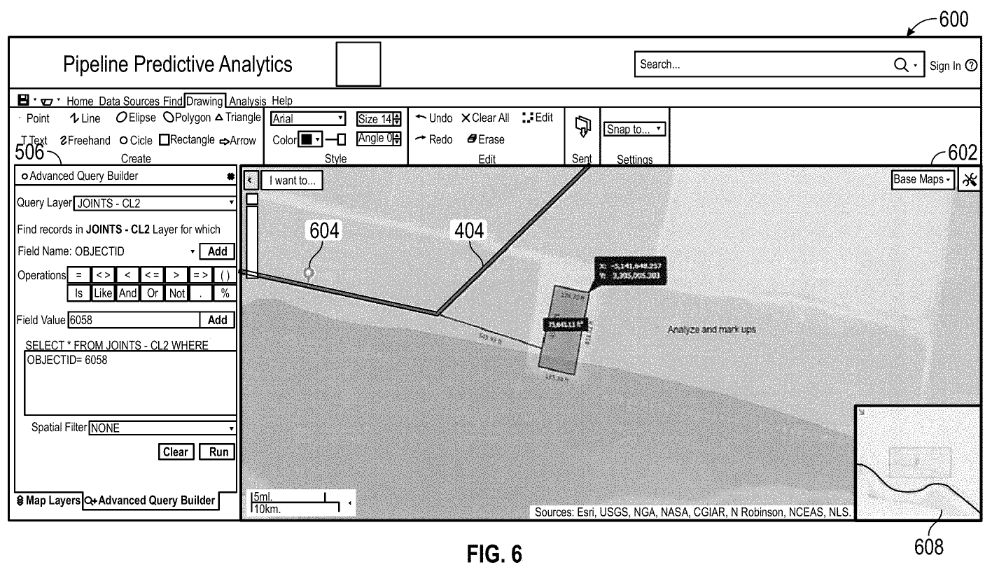

In step 116, a representation of each structural component is displayed on a map, using the client interface, video interface and/or the GUI described further in reference to FIG. 8, with a link to its respective structural data and geospatial data from step 102 and its respective relative probability of failure rank and failure consequence rank from step 112. In FIG. 4, a display 400 illustrates one embodiment of a GUI for displaying a representation of each structural component (e.g. joints and welds in a pipeline) on a map 402. Because the matrix 301 in FIG. 3 represents the same structural components (e.g. joints and welds) as the structural components represented on the map 402, the GUI in FIG. 3 may be used to link each structural component referenced by the number in a matrix cell to the geospatial location of each structural component on the map 402. Each structural component displayed on the map 402 may or may not be connected. Structural components comprising connected joints and welds in the pipeline 404 may however, be selectively displayed on the map 402 according to their geospatial location with the same grayscale risk rank as the matrix cell(s) in FIG. 3 representing the respective structural components. In addition, a map layers' menu 406 may be used to display multiple pipelines of interest on the map 402 and various geospatial objects (e.g. fault lines, flood zones, earthquakes, soil studies, critical habitats, places of interest, landslide prone areas, roads, railroads, other nearby pipelines and rivers) that could impact the structural integrity of the pipeline(s). An overview map 408 may also be used to display a larger area surrounding the map 402. In FIG. 5, a display 500 illustrates another embodiment of the GUI in FIG. 4 for displaying a representation of each structural component (e.g. joints and welds in a pipeline) on the map 402 with a link to its respective structural data and geospatial data and its respective relative probability of failure rank and failure consequence rank using an advanced query builder menu 506. The advanced query builder menu 506 enables a link to the structural data, geospatial data, relative probability of failure rank and failure consequence rank for each structural component that is displayed in GUI window 508. In addition, the advanced query builder menu 506 enables a link to the probability of failure criteria, respective multipliers and respective weights, and to the failure consequence criteria and respective weights. In this embodiment, the advanced query builder menu 506 enables a metadata link that may also be used to selectively search datasets and display the data results according to their geospatial location on the map 402. For example, structural components in the pipeline 404 with the highest grayscale risk rank may be selectively searched and displayed on the map 402 according to their geospatial location. Moreover, the advanced query builder menu 506 enables a metadata link to the geospatial data for a geospatial object (e.g. fault lines, flood zones, earthquakes, soil studies, critical habitats, places of interest, landslide prone areas, roads, railroads, other nearby pipelines and rivers) selected on the map 402. In FIG. 6, a display 600 illustrates another embodiment of the GUI in FIG. 4 for optionally displaying a select portion of the pipeline 404 on another map 602 using the advanced query builder menu 506. In this embodiment, the select portion of the pipeline 404 may be displayed on the another map 602 with various inserts (e.g. distances, notes, etc.) needed to address the integrity of a specific structural component 604 with a high grayscale risk rank in FIG. 5. An overview map 608 may also be used to display a larger area surrounding the map 602. The map 602 may be converted to a pdf for off-line use and/or sharing.

In step 118, the method 100 determines whether to input additional structural data and/or geospatial data for a structural component based on availability. Additional structural data and/or geospatial data may include data that was previously unavailable and updated data that is time-dependent. The determination may be automatic or may be made using the client interface, the video interface and/or the GUI described further in reference to FIG. 8. If additional structural data and/or geospatial data is available for a structural component, then the method 100 returns to step 102. Otherwise, the method 100 proceeds to step 120.

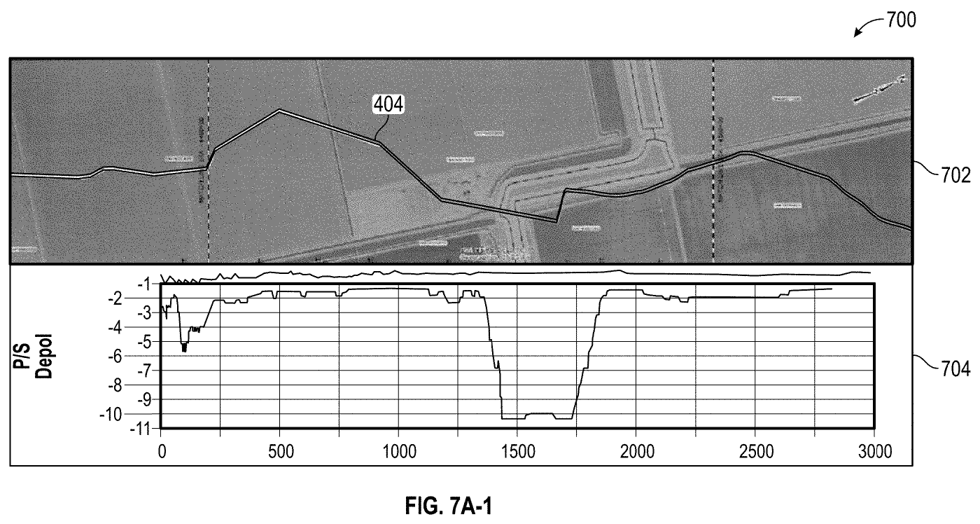

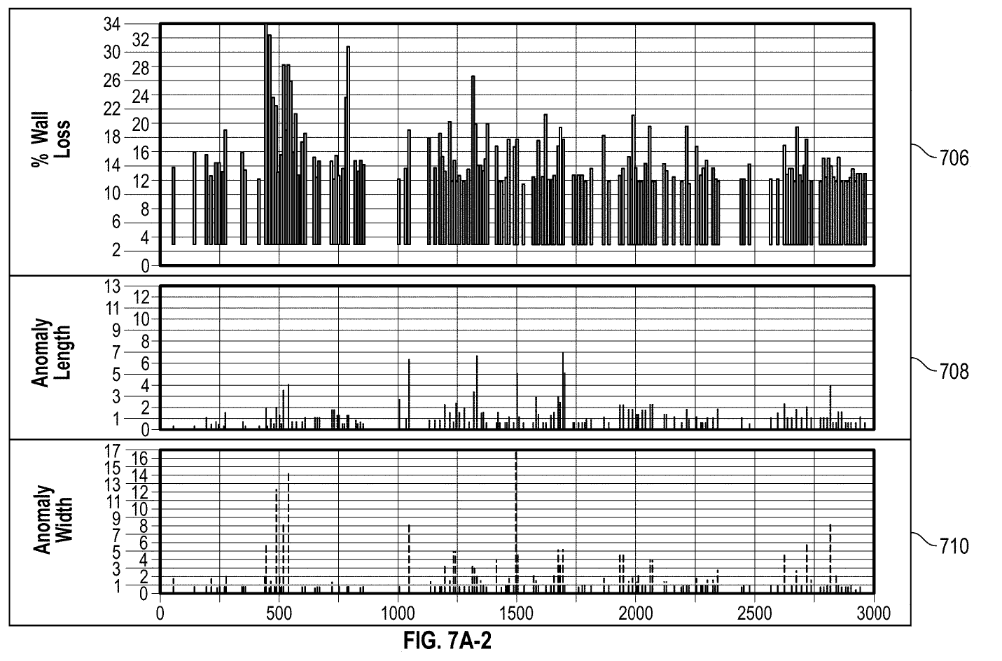

In step 120, the last relative probability of failure rank for each structural component from step 112 may be validated using a physical integrity inspection of each structural component within a predetermined time-frame, the client interface, the video interface and/or the GUI described further in reference to FIG. 8. Mechanical devices called pigs are often used to physically inspect the integrity of a pipeline through in-line inspection. Gauging or sizing pigs are typically run following the completion of new construction or line repair to determine if there are any internal obstructions, bends, or buckles in the pipe. Pigs can also be equipped with cameras to allow internal viewing of the pipe joints and welds. Electronic smart pigs, which use magnetic and ultrasonic systems, locate and measure internal and external corrosion pitting, dents, buckles, and any other anomalies in the pipe wall. The results of a pig inspection may therefore, be used to validate the last relative probability of failure rank for each structural component from step 112. In FIG. 7, a display 700 illustrates one embodiment of a GUI for displaying a representation of each structural component (joints and welds in a pipeline) in the pipeline 404 on a map 702. Structural components comprising connected joints and welds in the pipeline 404 may therefore, be selectively displayed on the map 702 according to their geospatial location with the same grayscale risk rank as the matrix cell(s) in FIG. 3 representing the respective structural components. In addition, the display 700 includes the results of an in-line integrity inspection of the pipeline 404 using a pig. The results are graphically displayed in windows that include a P/S Depol window 704, % Wall Loss window 706, Anomaly Length window 708 and Anomaly Width window 710. The graphical results for each window are displayed in vertical alignment with the pipeline 404 on map 702 so that the results may be compared with the respective structural component (joint or weld) in the pipeline 404 that was inspected by the pig. In this manner, the last relative probability of failure rank for each structural component from step 112 may be quickly and easily validated using the results of the in-line integrity inspection. If, for example, there is a discrepancy between the grayscale risk rank of a particular joint in the pipeline 404 and the corresponding, vertically aligned, in-line integrity inspection results graphically displayed in one of the windows 704-710, then the validity of the last relative probability of failure rank for that structural component (joint) may be questioned.

In step 122, one or more structural components are physically inspected, repaired and/or replaced based on the displays in steps 114 and/or 116, and/or the validation from step 120. Using at least one of the displays in FIGS. 3-7 illustrating steps 114, 116 and 120, one or more joints in the pipeline 404 may require a physical inspection that results in no further action or may require the repair or replacement of one or more joints.

The method 100 accurately and efficiently identifies structural integrity risks, where (geospatially) they may occur and the severity of the consequence if a failure occurs in that location. The method 100 may therefore, be used to support owners and operators of preexisting pipelines that are subject to PHMSA regulations. The method 100 may also be used in the process of designing structures with fewer potential failures and consequences.

The present disclosure may be implemented through a computer-executable program of instructions, such as program modules, generally referred to as software applications or application programs executed by a computer. The software may include, for example, routines, programs, objects, components and data structures that perform particular tasks or implement particular abstract data types. The software forms an interface to allow a computer to react according to a source of input. A predictive modeling software platform may be used as an interface application to implement the present disclosure. The software may also cooperate with other code segments to initiate a variety of tasks in response to data received in conjunction with the source of the received data. The software may be stored and/or carried on any variety of memory such as CD-ROM, magnetic disk, bubble memory and semiconductor memory (e.g. various types of RAM or ROM). Furthermore, the software and its results may be transmitted over a variety of carrier media such as optical fiber, metallic wire and/or through any of a variety of networks, such as the Internet.

Moreover, those skilled in the art will appreciate that the disclosure may be practiced with a variety of computer-system configurations, including hand-held devices, multiprocessor systems, microprocessor-based or programmable-consumer electronics, minicomputers, mainframe computers, and the like. Any number of computer-systems and computer networks are acceptable for use with the present disclosure. The disclosure may be practiced in distributed-computing environments where tasks are performed by remote-processing devices that are linked through a communications network. In a distributed-computing environment, program modules may be located in both local and remote computer-storage media including memory storage devices. The present disclosure may therefore, be implemented in connection with various hardware, software or a combination thereof, in a computer system or other processing system.

Referring now to FIG. 8, a block diagram illustrates one embodiment of a system for implementing the present disclosure on a computer. The system includes a computing unit, sometimes referred to as a computing system, which contains memory, application programs, a client interface, a video interface, and a processing unit. The computing unit is only one example of a suitable computing environment and is not intended to suggest any limitation as to the scope of use or functionality of the disclosure.

The memory primarily stores the application programs, which may also be described as program modules containing computer-executable instructions, executed by the computing unit for implementing the present disclosure described herein and illustrated in FIGS. 1-7. The memory therefore, includes a structural integrity evaluation module, which enables steps 102, 110, 116-120 described in reference to FIGS. 1A-1B. The structural integrity evaluation module may integrate functionality from the remaining application programs illustrated in FIG. 8. In particular, the predictive modeling platform may be used as an interface application to perform steps 104-108 and 112-114. Although the predictive modeling platform may be used as interface application, other interface applications may be used, instead, or the structural integrity evaluation module may be used as a stand-alone application.

Although the computing unit is shown as having a generalized memory, the computing unit typically includes a variety of computer readable media. By way of example, and not limitation, computer readable media may comprise computer storage media and communication media. The computing system memory may include computer storage media in the form of volatile and/or nonvolatile memory such as a read only memory (ROM) and random access memory (RAM). A basic input/output system (BIOS), containing the basic routines that help to transfer information between elements within the computing unit, such as during start-up, is typically stored in ROM. The RAM typically contains data and/or program modules that are immediately accessible to, and/or presently being operated on, the processing unit. By way of example, and not limitation, the computing unit includes an operating system, application programs, other program modules, and program data.

The components shown in the memory may also be included in other removable/nonremovable, volatile/nonvolatile computer storage media or they may be implemented in the computing unit through an application program interface (“API”) or cloud computing, which may reside on a separate computing unit connected through a computer system or network. For example only, a hard disk drive may read from or write to nonremovable, nonvolatile magnetic media, a magnetic disk drive may read from or write to a removable, nonvolatile magnetic disk, and an optical disk drive may read from or write to a removable, nonvolatile optical disk such as a CD ROM or other optical media. Other removable/nonremovable, volatile/nonvolatile computer storage media that can be used in the exemplary operating environment may include, but are not limited to, magnetic tape cassettes, flash memory cards, digital versatile disks, digital video tape, solid state RAM, solid state ROM, and the like. The drives and their associated computer storage media discussed above provide storage of computer readable instructions, data structures, program modules and other data for the computing unit.

A client may enter commands and information into the computing unit through the client interface, which may be input devices such as a keyboard and pointing device, commonly referred to as a mouse, trackball or touch pad. Input devices may include a microphone, joystick, satellite dish, scanner, or the like. These and other input devices are often connected to the processing unit through the client interface that is coupled to a system bus, but may be connected by other interface and bus structures, such as a parallel port or a universal serial bus (USB).

A monitor or other type of display device may be connected to the system bus via an interface, such as a video interface. A GUI may also be used with the video interface to receive instructions from the client interface and transmit instructions to the processing unit. In addition to the monitor, computers may also include other peripheral output devices such as speakers and printer, which may be connected through an output peripheral interface.

Although many other internal components of the computing unit are not shown, those of ordinary skill in the art will appreciate that such components and their interconnection are well-known.

While the present disclosure has been described in connection with presently preferred embodiments, it will be understood by those skilled in the art that it is not intended to limit the disclosure to those embodiments. For example, the present disclosure has been described with respect to pipeline structures, however, it is not limited thereto and may also be applied to other structures (e.g. transmission lines, railroads, tunnels, etc.) to achieve similar results. It is therefore, contemplated that various alternative embodiments and modifications may be made to the disclosed embodiments without departing from the spirit and scope of the disclosure defined by the appended claims and equivalents thereof.

1. A method for evaluating and maintaining structural integrity, which comprises:
a) inputting structural data and geospatial data into a geographical information system for each structural component;
b) inputting i) probability of failure criteria, a respective multiplier and respective weights into the geographical information system for each structural component and ii) failure consequence criteria and respective weights into the geographical information system for each structural component;
c) correlating the structural data and the geospatial data for each structural component with i) the probability of failure criteria or modified probability of failure criteria, the respective multiplier or a modified respective multiplier and each respective weight or each modified respective weight and ii) the failure consequence criteria or modified failure consequence criteria and each respective weight or each modified respective weight;
d) determining a relative probability of failure rank and an independent failure consequence rank for each structural component based on the correlation from step c) using a computer processor;
e) displaying a representation of each structural component in a matrix on a computer monitor based on the relative probability of failure rank and the independent failure consequence rank for each structural component; and
f) inspecting one or more structural components based on the display.

2. The method of claim 1, wherein each structural component belongs to a predetermined set of one or more structural components.

3. The method of claim 1, wherein one of i) one of the probability of failure criteria, a respective multiplier and each respective weight and ii) one of the failure consequence criteria and each respective weight are modified.

4. The method of claim 1, further comprising displaying a representation of each structural component on a map with a link to i) the respective structural data and geospatial data and ii) the respective relative probability of failure rank and failure consequence rank.

5. The method of claim 1, further comprising;
inputting one of additional structural data and additional geospatial data into the geographical information system for a structural component; and
repeating steps b)-e).

6. The method of claim 1, further comprising validating the relative probability of failure rank for each structural component using results from a physical integrity inspection of each structural component within a predetermined time-frame.

7. The method of claim 6, further comprising repairing or replacing one or more structural components based on the validation of the relative probability of failure rank for each structural component.

8. The method of claim 2, wherein one predetermined set of structural components comprises pipeline joints and another predetermined set of structural components comprises pipeline welds.

9. The method of claim 1, wherein the structural data comprises at least one of a pipeline type, a pipeline coating type, a welding type and pipeline coordinates for each structural component.

10. The method of claim 1, wherein the geospatial data comprises at least one of fault lines, flood zones, earthquakes, soil studies, critical habitats, places of interest, landslide prone areas, roads, railroads, rivers and other similar structures in a predetermined area.

11. The method of claim 1, wherein each respective weight for each probability of failure criteria and each respective weight for each failure consequence criteria is associated with at least one database query.

12. The method of claim 1, wherein the probability of failure criteria are based on a type of structure.

13. The method of claim 1, wherein the failure consequence criteria are based on a failure impact on at least one of a predetermined environmental area, a population within a predetermined area and an infrastructure within a predetermined area.

14. The method of claim 1, wherein each respective weight for each probability of failure criteria and each respective weight for each failure consequence criteria is based on a severity of a failure of the respective structural component.

15. The method of claim 11, wherein the correlating step finds the structural data and the geospatial data for each structural component that most closely corresponds to one or more of the database queries associated with the respective weight.

16. The method of claim 15, wherein the relative probability of failure rank is determined by adding the weights associated with the correlated database queries for each structural component and dividing the added weight for each structural component by a total weight representing a sum of the weights associated with a respective database query for each respective structural component.

17. The method of claim 15, wherein the failure consequence rank is determined by adding the weights associated with the correlated database queries for each structural component.

18. The method of claim 1, wherein each cell in the matrix includes a number that represents the structural components associated with the respective cell.

19. The method of claim 18, wherein each cell in the matrix includes a gray-scale shade that represents an overall risk rank for the structural components associated with the respective cell.

20. The method of claim 6, wherein the physical integrity inspection is performed using a pig to inspect the structural components of a pipeline.

21. A non-transitory program carrier device tangibly carrying computer-executable instructions for evaluating and maintaining structural integrity, the instructions being executable to implement;
a) inputting structural data and geospatial data into a geographical information system for each structural component;
b) inputting i) probability of failure criteria, a respective multiplier and respective weights into the geographical information system for each structural component and ii) failure consequence criteria and respective weights into the geographical information system for each structural component;
c) correlating the structural data and the geospatial data for each structural component with i) the probability of failure criteria or modified probability of failure criteria, the respective multiplier or a modified respective multiplier and each respective weight or each modified respective weight and ii) the failure consequence criteria or modified failure consequence criteria and each respective weight or each modified respective weight;
d) determining a relative probability of failure rank and an independent failure consequence rank for each structural component based on the correlation from step c);
e) displaying a representation of each structural component on a matrix based on the relative probability of failure rank and the independent failure consequence rank for each structural component; and
f) inspecting one or more structural components based on the display.

22. The program carrier device of claim 21, wherein each structural component belongs to a predetermined set of one or more structural components.

23. The program carrier device of claim 21, wherein one of i) one of the probability of failure criteria, a respective multiplier and each respective weight and ii) one of the failure consequence criteria and each respective weight are modified.

24. The program carrier device of claim 21, further comprising displaying a representation of each structural component on a map with a link to i) the respective structural data and geospatial data and ii) the respective relative probability of failure rank and failure consequence rank.

25. The program carrier device of claim 21, further comprising;
inputting one of additional structural data and additional geospatial data into the geographical information system for a structural component; and
repeating steps b)-e).

26. The program carrier device of claim 21, further comprising validating the relative probability of failure rank for each structural component using results from a physical integrity inspection of each structural component within a predetermined time-frame.

27. The program carrier device of claim 26, further comprising repairing or replacing one or more structural components based on the validation of the relative probability of failure rank for each structural component.

28. The program carrier device of claim 22, wherein one predetermined set of structural components comprises pipeline joints and another predetermined set of structural components comprises pipeline welds.

29. The program carrier device of claim 21, wherein the structural data comprises at least one of a pipeline type, a pipeline coating type, a welding type and pipeline coordinates for each structural component.

30. The program carrier device of claim 21, wherein the geospatial data comprises at least one of fault lines, flood zones, earthquakes, soil studies, critical habitats, places of interest, landslide prone areas, roads, railroads, rivers and other similar structures in a predetermined area.

31. The program carrier device of claim 21, wherein each respective weight for each probability of failure criteria and each respective weight for each failure consequence criteria is associated with at least one database query.

32. The program carrier device of claim 21, wherein the probability of failure criteria are based on a type of structure.

33. The program carrier device of claim 21, wherein the failure consequence criteria are based on a failure impact on at least one of a predetermined environmental area, a population within a predetermined area and an infrastructure within a predetermined area.

34. The program carrier device of claim 21, wherein each respective weight for each probability of failure criteria and each respective weight for each failure consequence criteria is based on a severity of a failure of the respective structural component.

35. The program carrier device of claim 31, wherein the correlating step finds the structural data and the geospatial data for each structural component that most closely corresponds to one or more of the database queries associated with the respective weight.

36. The program carrier device of claim 35, wherein the relative probability of failure rank is determined by adding the weights associated with the correlated database queries for each structural component and dividing the added weight for each structural component by a total weight representing a sum of the weights associated with a respective database query for each respective structural component.

37. The program carrier device of claim 35, wherein the failure consequence rank is determined by adding the weights associated with the correlated database queries for each structural component.

38. The program carrier device of claim 1, wherein each cell in the matrix includes a number that represents the structural components associated with the respective cell.

39. The program carrier device of claim 38, wherein each cell in the matrix includes a gray-scale shade that represents an overall risk rank for the structural components associated with the respective cell.

40. The program carrier device of claim 26, wherein the physical integrity inspection is performed using a pig to inspect the structural components of a pipeline.
